(19) United States
(12) Patent Application Publication
(10) Pub. No.: US 2006/0077864 A1
(43) Pub. Date: Apr. 13, 2006

(54) Semiconductor laser device and optical pickup device having the device

(75) Inventor: Hiroshi Katayama, Higashihiroshima-Shi (JP)

Correspondence Address: MORRISON & FOERSTER LLP, 1650 TYSONS BOULEVARD, SUITE 300, MCLEAN, VA, 22102, US

(73) Assignee: SHARP KABUSHIKI KAISHA, Osaka-shi (JP)

(21) Appl. No.: 11/219,762

(22) Filed: Sep. 7, 2005

(30) Foreign Application Priority Data
Sep. 8, 2004 (JP) 2004-260726

(51) Int. Cl. G11B 7/00

(52) U.S. Cl. 369/121

(57) ABSTRACT

A semiconductor laser device includes a thin metal plate having a mounting surface, and an LD chip having a front end surface from which laser light is emitted. The thin metal plate has radius portions so as to enable the thin metal plate to turn around the neighborhood of the light-emitting point of the LD chip along a plane parallel to the mounting surface. This arrangement prevents a bad influence from exerting on the recording and reproduction characteristics of the information of an optical disk having the semiconductor device.

### CROSS-REFERENCE TO RELATED APPLICATIONS

This nonprovisional application claims priority under 35 U.S.C. §119(a) on Patent Application No. 2004-260726 filed in Japan on 8 Sep. 2004, the entire contents of which are incorporated herein by reference.

### BACKGROUND OF THE INVENTION

The present invention relates to a semiconductor laser device in which a semiconductor laser element is mounted on a metal plate, and relates to an optical pickup device which is mounted with the semiconductor laser device and performs at least one of reproduction, erase and recording of information on an optical disk of CD (Compact Disc), DVD (Digital Versatile Disc) or the like.

The optical pickup device has a laser diode chip as a light source and operates to record information on the optical disk, reproduce the information recorded on the optical disk and erase the information recorded on the optical disk.

FIG. 28 shows a conceptual diagram of the basic structure of a conventional optical pickup device.

The optical pickup device has a semiconductor laser device 1700, a collimating lens 1761 and an object lens 1762.

According to the optical pickup device of this construction, laser light emitted from the semiconductor laser device 1700 is converted roughly into parallel light by the collimating lens 1761 and is condensed on the recording surface of an optical disk 1763 by the object lens 1762. With this arrangement, information is recorded on the optical disk 1763, the information recorded on the optical disk 1763 is reproduced, or the information recorded on the optical disk 1763 is erased.

FIG. 28 does not show a signal detection system such as a photodetector necessary for reproducing, recording and erasing of information on the optical disk 1763 and a mechanism necessary for focus control of the laser light to the optical disk 1763.

FIG. 29 shows a basic structural diagram of the conventional semiconductor laser device 1700.

The semiconductor laser device 1700 is generally called the frame laser. In the semiconductor laser device 1700, a laser diode chip (hereinafter referred to as an “LD chip”) 1702 is mounted on a thin metal plate 1701 via an indium or silver paste or the like.

The LD chip 1702 emits laser light from a laser light emitting end surface (front end surface) 1702a. The laser light has an elliptic light intensity distribution as shown in FIG. 29. The light intensity distribution results because the LD chip 1702 has the following structure.

The X axis of FIG. 29 is parallel to the upper surface (surface on which the LD chip 1702 is mounted) of the thin metal plate 1701 and parallel to the laser light emitting end surface 1702a of the LD chip 1702. The Y axis of FIG. 29 is directed perpendicular to the surface of the thin metal plate 1701. The Z axis of FIG. 29 is parallel to the upper surface of the thin metal plate 1701 and perpendicular to the laser light emitting end surface 1702a of the LD chip 1702.

As shown in FIG. 30, the LD chip 1702 has six surfaces.

The six surfaces include two surfaces parallel to the XY plane. One of the two surfaces is the laser light emitting end surface 1702a, which is a surface having an accuracy on the atomic level produced by cleavage. The other of the two surfaces is a rear end surface 1702b of the LD chip 1702.

In producing the LD chip 1702, the crystal growth direction is the Y-axis direction of FIG. 30, i.e., parallel to the thickness direction of the LD chip 1702. Therefore, an electrode (anode electrode or cathode electrode) for emitting laser light by flowing a current has a surface perpendicular to the Y-axis direction.

The two surfaces, which are parallel to the YZ plane, of the six surfaces are diced surfaces 1702c and 1702d formed when the LD chip 1702 is cut from a wafer.

The LD chip 1702 has the dimensions of a length of about 300 to 1000 μm in the Z-axis direction, a length of about 300 μm in the X-axis direction and a length of about 100 μm in the Y-axis direction.

The LD chip 1702 needs to radiate heat since it generates heat when emitting light, and, of course, the LD chip 1702 should preferably have a higher heat radiation property.

In order to improve the heat radiation property of the LD chip 1702, it is required to efficiently transfer the heat of the LD chip 1702 to the mounting surface of the thin metal plate 1701 for the LD chip 1702. That is, a thermal resistance between the LD chip 1702 and the thin metal plate 1701 should desirably be small.

In order to improve the heat radiation property of the LD chip 1702, the LD chip 1702 is normally fixed to the thin metal plate 1701 with use of a material of, for example, an indium or silver paste having a good thermal conductivity. The material has electrical conductivity.

When performing fixation with the material, it is impossible to use the method of fixing the diced surface to the LD chip mounting surface 1702 of the thin metal plate 1701 with the above-stated material since the anode electrode and the cathode electrode are short-circuited to each other by the material.

In order to prevent the short circuit, in the semiconductor laser device 1700, one surface of the anode electrode or the cathode electrode is fixed to the LD chip mounting surface 1702 of the thin metal plate 1701 with the material. In this case, the anode electrode or the cathode electrode is electrically connected to the thin metal plate 1701, and therefore, the thin metal plate 1701 is a heat sink that concurrently serves as the anode electrode terminal or the cathode electrode terminal of the semiconductor laser device 1700.

Moreover, since the semiconductor laser device 1700 has a crystal growth direction parallel to the Y-axis direction, light confinement in the Y-axis direction is intense, and light confinement in the X-axis direction is weak. Therefore, as shown in FIG. 29, the intensity distribution of the laser light becomes elliptic with the minor axis extending in the X-axis direction and the major axis extending in the Y-axis direction.

The flare angle in the X-axis direction of the light intensity distribution is generally referred to as θ∥, and the flare angle in the Y-axis direction of the light intensity distribution is referred to as θ⊥.

The electrode, which is not put in contact with the thin metal plate 1701, among the anode electrode and the cathode electrode is subjected to wire bonding employing a gold wire. With this arrangement, the electrode, which is not put in contact with the thin metal plate 1701, is electrically connected to a laser terminal (not shown). The LD chip 1702 is fed with a current via the laser terminal.

FIG. 31 shows a basic structural diagram of another conventional semiconductor laser device 1800.

In the semiconductor laser device 1800, a resin part 1803 is integrally molded with a thin metal plate 1801 in order to protect the LD chip 1802 and the gold wire.

In the semiconductor laser device, an inclination caused when the LD chip 1802 is fixed to the thin metal plate 1801 becomes a problem.

In general, the inclination accuracies Δθ∥ and Δθ⊥ of the LD chip 1802 are two to three degrees. That is, the LD chip 1802 might sometimes be attached to the LD chip 1802 mounting surface of the thin metal plate 1801 disadvantageously inclined by ±2 to 3° in the X-axis and Y-axis directions with respect to a prescribed direction.

Since the flare angle θ⊥ in the Y-axis direction of the light intensity distribution is great as described above, a bad influence of the inclination accuracy Δθ⊥ of the LD chip 1802 exerted on the characteristics of the optical pickup device is small.

However, since the flare angle θ∥ in the X-axis direction of the light intensity distribution is small as described above, the inclination accuracy Δθ∥ of the LD chip 1802 deteriorates the quality of the light spot condensed on the recording surface of the optical disk and exerts a bad influence upon the recording and reproduction characteristics of the information of the optical disk.

In order to prevent the deterioration of the recording and reproduction characteristics, the semiconductor laser device is subjected to inclination adjustment (rotational adjustment) in the direction of θ∥. Specifically, the inclination adjustment of the semiconductor laser device in the direction of θ∥ is performed by turn of the thin metal plate 1801 in a state in which the thin metal plate of the semiconductor laser device comes in contact with the mounting surface of the semiconductor laser device in the housing of the optical pickup device. The inclination adjustment is performed while measuring the light intensity distribution of the laser light by a CCD (Charge Coupled Device) camera or the like.

However, when the inclination adjustment of the semiconductor laser device in the direction of q∥ is performed, the position of the light-emitting point of the LD chip 1802 is disadvantageously changed. As the result, the optical axis of the laser light incident on the collimating lens and the object lens is inclined, and therefore, an extra-axial aberration occurs so that the recording and reproduction characteristics deteriorate. That is, the deterioration in the recording and reproduction characteristics cannot be avoided by the inclination adjustment of the semiconductor laser device in the direction of q∥.

In FIG. 31, the reference numeral 1802a denotes a laser light emitting end surface, and reference numeral 1801a denotes a mounting surface. JP 2002-176222 A is given as the prior art.

### SUMMARY OF THE INVENTION

An object of the present invention is to provide a semiconductor laser device capable of preventing a bad influence from being exerted on the recording and reproduction characteristics of the information of an optical disk and an optical pickup device provided with the device.

In order to achieve the above-mentioned object, a first aspect of the present invention provides a semiconductor laser device comprising:

a main body part having a mounting surface; and

a semiconductor laser element mounted on the mounting surface and having a front end surface from which laser light is emitted, wherein

a first turn guide mechanism is formed at the main body part, the first turn guide mechanism enabling the main body part to turn around a neighborhood of a light-emitting point of the semiconductor laser element along a plane parallel to the mounting surface.

According to the semiconductor laser device of this construction, forming the first turn guide mechanism on the main body part makes it possible to turn the main body part around the neighborhood of the light-emitting point of the semiconductor laser element along the plane parallel to the mounting surface. Therefore, the inclination adjustment of the semiconductor laser element in the direction of q∥ is performed without causing any positional deviation of the light-emitting point of the semiconductor laser element. Thus, when the semiconductor laser device is mounted on an optical pickup device, a bad influence can be prevented from being exerted on the recording and reproduction characteristics of the information of the optical disk.

In one embodiment of the present invention, at least part of an edge portion of the main body part roughly overlaps a circumference of a circle centered at the light-emitting point in plan view.

In a third In one embodiment of the present invention, the main body part is formed by:

a metal plate having the mounting surface; and

a resin part formed integrally with the metal plate and provided with the first turn guide mechanism.

In a fourth In one embodiment of the present invention, the first turn guide mechanism is a radius portion formed at an edge portion of the main body part, and

the radius portion roughly overlaps a circular arc of a circle centered at the light-emitting point in plan view.

In a fifth In one embodiment of the present invention, the first turn guide mechanism is comprised of two first angled portions formed at an edge portion of the main body part, and

each apex of the first angled portions is located at a point on a circumference of a circle centered at the light-emitting point in plan view.

In a sixth In one embodiment of the present invention, a straight line, which extends through each of the ends of the first angled portions and the neighborhood of the light-emitting point, intersects a side surface of the main body part making an acute angle with respect to the side surface.

In a seventh In one embodiment of the present invention, a wire bonding wire is electrically connected to a surface of the semiconductor laser element, the surface being located opposite to the metal plate,

a surface of the resin part is higher than a portion of the wire bonding wire, the surface and the portion being located on a side opposite to the metal plate, and

the resin part is formed so as to face a rear end surface and two side surfaces of the semiconductor laser element.

In one embodiment of the present invention, the resin part is formed of a resin material having electrical conductivity.

In one embodiment of the present invention, the resin material contains powdery metal or particulate metal.

In one embodiment of the present invention, the first turn guide mechanism is a recess formed on a surface of the main body part, the surface being located on a side opposite to the semiconductor laser element.

In one embodiment of the present invention, the recess is formed so as to roughly overlap the light-emitting point.

In one embodiment of the present invention, the recess has an open portion on a side of the front end surface of the semiconductor laser element.

In one embodiment of the present invention, the recess is a groove that roughly overlaps a circumference of a circle centered at the light-emitting point in plan view.

In one embodiment of the present invention, the recess is a cut formed at an edge portion of the main body part, and

the cut has a width approximately equal to that of the semiconductor laser element.

A second aspect of the present invention provides an optical pickup device comprising:

the above-stated semiconductor laser device; and

a housing having a mounting surface to which the semiconductor laser device is attached, wherein

a second turn guide mechanism is formed at the housing, the second turn guide mechanism enabling the main body part to turn around a neighborhood of the light-emitting point of the semiconductor laser element along a plane parallel to the mounting surface with respect to the housing.

According to the optical pickup device of this construction, by forming the second turn guide mechanism at the housing, the main body part can be turned around the neighborhood of the light-emitting point of the semiconductor laser element along the plane parallel to the mounting surface with respect to the housing. Therefore, the inclination adjustment in the direction of θ∥ is performed without causing any positional deviation of the light-emitting point of the semiconductor laser element. Thus, a bad influence can be prevented from being exerted on the recording and reproduction characteristics of the information of the optical disk.

A third aspect of the present invention provides an optical pickup device comprising:

the semiconductor laser device claimed in claim 4; and

a housing having a mounting surface to which the semiconductor laser device is attached, wherein

a second turn guide mechanism is formed at the housing, the second turn guide mechanism enabling the main body part to turn around a neighborhood of the light-emitting point of the semiconductor laser element along a plane parallel to the mounting surface with respect to the housing,

the second turn guide mechanism is a curved surface that comes in contact with the radius portion, and

the curved surface roughly overlaps a circular arc of a circle centered at the light-emitting point in plan view.

According to the optical pickup device of this construction, by forming the second turn guide mechanism at the housing, the main body part can be turned around the neighborhood of the light-emitting point of the semiconductor laser element along the plane parallel to the mounting surface with respect to the housing. Therefore, the inclination adjustment in the direction of θ∥ is performed without causing the positional deviation of the light-emitting point of the semiconductor laser element. Thus, a bad influence can be prevented from being exerted on the recording and reproduction characteristics of the information of the optical disk.

A fourth aspect of the present invention provides an optical pickup device comprising:

the semiconductor laser device claimed in claim 4; and

a housing having a mounting surface to which the semiconductor laser device is attached, wherein

a second turn guide mechanism is formed at the housing, the second turn guide mechanism enabling the main body part to turn around a neighborhood of the light-emitting point of the semiconductor laser element along a plane parallel to the mounting surface with respect to the housing,

the second turn guide mechanism is a plane that comes in contact with the radius portion, and

the plane roughly overlaps a tangential line to the radius portion.

According to the optical pickup device of this construction, by forming the second turn guide mechanism at the housing, the main body part can be turned around the neighborhood of the light-emitting point of the semiconductor laser element along the plane parallel to the mounting surface with respect to the housing. Therefore, the inclination adjustment in the direction of θ∥ is performed without causing the positional deviation of the light-emitting point of the semiconductor laser element. Thus, a bad influence can be prevented from being exerted on the recording and reproduction characteristics of the information of the optical disk.

A fifth aspect of the present invention provides an optical pickup device comprising:

the semiconductor laser device claimed in claim 4; and

a housing having a mounting surface to which the semiconductor laser device is attached, wherein

a second turn guide mechanism is formed at the housing, the second turn guide mechanism enabling the main body part to turn around a neighborhood of the light-emitting point of the semiconductor laser element along a plane parallel to the mounting surface with respect to the housing,

the second turn guide mechanism is comprised of two second angled portions that come in contact with the radius portion, and

apexes of the second angled portions roughly overlap points on a circumference of a circle centered at the light-emitting point in plan view.

According to the optical pickup device of this construction, by forming the second turn guide mechanism at the housing, the main body part can be turned around the neighborhood of the light-emitting point of the semiconductor laser element along the plane parallel to the mounting surface with respect to the housing. Therefore, the inclination adjustment in the direction of θ∥ is performed without causing the positional deviation of the light-emitting point of the semiconductor laser element. Thus, a bad influence can be prevented from being exerted on the recording and reproduction characteristics of the information of the optical disk.

A sixth aspect of the present invention provides an optical pickup device comprising:

the semiconductor laser device claimed in claim 5; and

a housing having a mounting surface to which the semiconductor laser device is attached, wherein

a second turn guide mechanism is formed at the housing, the second turn guide mechanism enabling the main body part to turn around a neighborhood of the light-emitting point of the semiconductor laser element along a plane parallel to the mounting surface with respect to the housing,

the second turn guide mechanism is a curved surface with which the first angled portion comes in contact, and

the curved surface roughly overlaps a circular arc of a circle centered at the light-emitting point in plan view.

According to the optical pickup device of this construction, by forming the second turn guide mechanism at the housing, the main body part can be turned around the neighborhood of the light-emitting point of the semiconductor laser element along the plane parallel to the mounting surface with respect to the housing. Therefore, the inclination adjustment in the direction of θ∥ is performed without causing the positional deviation of the light-emitting point of the semiconductor laser element. Thus, a bad influence can be prevented from being exerted on the recording and reproduction characteristics of the information of the optical disk.

A seventh aspect of the present invention provides an optical pickup device comprising:

the semiconductor laser device claimed in claim 10; and

a housing having a mounting surface to which the semiconductor laser device is attached, wherein

a second turn guide mechanism is formed at the housing, the second turn guide mechanism enabling the main body part to turn around a neighborhood of the light-emitting point of the semiconductor laser element along a plane parallel to the mounting surface with respect to the housing,

the second turn guide mechanism is a projection formed on the mounting surface, and

the projection is fit in the recess.

According to the optical pickup device of this construction, by forming the second turn guide mechanism at the housing, the main body part can be turned around the neighborhood of the light-emitting point of the semiconductor laser element along the plane parallel to the mounting surface with respect to the housing. Therefore, the inclination adjustment in the direction of θ∥ is performed without causing the positional deviation of the light-emitting point of the semiconductor laser element. Thus, a bad influence can be prevented from being exerted on the recording and reproduction characteristics of the information of the optical disk.

In the semiconductor laser device of the first aspect of the invention, by forming the first turn guide mechanism on the main body part, the main body part can be turned around the neighborhood of the light-emitting point of the semiconductor laser element along the plane parallel to the mounting surface. Therefore, the inclination adjustment in the direction of θ∥ is performed without causing the positional deviation of the light-emitting point of the semiconductor laser element. Thus, when the semiconductor laser device is mounted on an optical pickup device, a bad influence can be prevented from being exerted on the recording and reproduction characteristics of the information of the optical disk.

In the semiconductor laser device of the second aspect of the invention, by forming the second turn guide mechanism at the housing, the main body part can be turned around the neighborhood of the light-emitting point of the semiconductor laser element along the plane parallel to the mounting surface with respect to the housing. Therefore, the inclination adjustment in the direction of θ∥ is performed without causing the positional deviation of the light-emitting point of the semiconductor laser element. Thus, a bad influence can be prevented from being exerted on the recording and reproduction characteristics of the information of the optical disk.

In the semiconductor laser device of the third aspect of the invention, by forming the second turn guide mechanism at the housing, the main body part can be turned around the neighborhood of the light-emitting point of the semiconductor laser element along the plane parallel to the mounting surface with respect to the housing. Therefore, the inclination adjustment in the direction of θ∥ is performed without causing the positional deviation of the light-emitting point of the semiconductor laser element. Thus, a bad influence can be prevented from being exerted on the recording and reproduction characteristics of the information of the optical disk.

In the semiconductor laser device of the fourth aspect of the invention, by forming the second turn guide mechanism at the housing, the main body part can be turned around the neighborhood of the light-emitting point of the semiconductor laser element along the plane parallel to the mounting surface with respect to the housing. Therefore, the inclination adjustment in the direction of θ∥ is performed without causing the positional deviation of the light-emitting point of the semiconductor laser element. Thus, a bad influence can be prevented from being exerted on the recording and reproduction characteristics of the information of the optical disk.

In the semiconductor laser device of the fifth aspect of the invention, by forming the second turn guide mechanism at the housing, the main body part can be turned around the neighborhood of the light-emitting point of the semiconductor laser element along the plane parallel to the mounting surface with respect to the housing. Therefore, the inclination adjustment in the direction of θ∥ is performed without causing the positional deviation of the light-emitting point of the semiconductor laser element. Thus, a bad influence can be prevented from being exerted on the recording and reproduction characteristics of the information of the optical disk.

In the semiconductor laser device of the sixth aspect of the invention, by forming the second turn guide mechanism at the housing, the main body part can be turned around the neighborhood of the light-emitting point of the semiconductor laser element along the plane parallel to the mounting surface with respect to the housing. Therefore, the inclination adjustment in the direction of θ∥ is performed without causing the positional deviation of the light-emitting point of the semiconductor laser element. Thus, a bad influence can be prevented from being exerted on the recording and reproduction characteristics of the information of the optical disk.

In the semiconductor laser device of the seventh aspect of the invention, by forming the second turn guide mechanism at the housing, the main body part can be turned around the neighborhood of the light-emitting point of the semiconductor laser element along the plane parallel to the mounting surface with respect to the housing. Therefore, the inclination adjustment in the direction of θ∥ is performed without causing the positional deviation of the light-emitting point of the semiconductor laser element. Thus, a bad influence can be prevented from being exerted on the recording and reproduction characteristics of the information of the optical disk.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a schematic perspective view of a substantial part of an optical pickup device according to a first embodiment of the present invention;

FIG. 2 is a schematic top view of the substantial part of the optical pickup device of the first embodiment;

FIG. 3 is a schematic perspective view of the substantial part of an optical pickup device according to a second embodiment of the present invention;

FIG. 4 is a schematic top view of the substantial part of the optical pickup device of the second embodiment;

FIG. 5 is a schematic perspective view of the substantial part of an optical pickup device according to a third embodiment of the present invention;

FIG. 6 is a schematic top view of the substantial part of the optical pickup device of the third embodiment;

FIG. 7 is a schematic perspective view of the substantial part of an optical pickup device according to a fourth embodiment of the present invention;

FIG. 8 is a schematic top view of the substantial part of a modification example of the optical pickup device of the fourth embodiment;

FIG. 9 is a schematic top view of the substantial part of an optical pickup device according to a fifth embodiment of the present invention;

FIG. 10 is a schematic side view of the substantial part of a modification example of the optical pickup device of the fifth embodiment;

FIG. 11 is a schematic perspective view of the semiconductor laser device of an optical pickup device according to a sixth embodiment of the present invention;

FIG. 12 is a schematic front view of the semiconductor laser device of the sixth embodiment;

FIG. 13 is a schematic perspective view of the semiconductor laser device of an optical pickup device according to a seventh embodiment of the present invention;

FIG. 14 is a schematic perspective view of the semiconductor laser device of an optical pickup device according to an eighth embodiment of the present invention;

FIG. 15 is a schematic perspective view of the semiconductor laser device of an optical pickup device according to a ninth embodiment of the present invention;

FIG. 16A is a schematic perspective view of the semiconductor laser device of an optical pickup device according to a tenth embodiment of the present invention;

FIG. 16B is a schematic sectional view of the semiconductor laser device of the tenth embodiment;

FIG. 17A is a schematic perspective view of the substantial part of an optical pickup device according to an eleventh embodiment of the present invention;

FIG. 17B is a schematic view for explaining the inclination adjustment of the semiconductor laser device of the eleventh embodiment;

FIG. 18A is a schematic perspective view of the substantial part of an optical pickup device according to a twelfth embodiment of the present invention;

FIG. 18B is a schematic view for explaining the inclination adjustment of the semiconductor laser device of the twelfth embodiment;

FIG. 19A is a schematic front view of the semiconductor laser device of an optical pickup device according to a thirteenth embodiment of the present invention;

FIG. 19B is a schematic bottom view of the semiconductor laser device of the thirteenth embodiment;

FIG. 20A is a schematic perspective view of the substantial part of an optical pickup device according to a fourteenth embodiment of the present invention;

FIG. 20B is a schematic view for explaining the inclination adjustment of the semiconductor laser device of the fourteenth embodiment;

FIG. 21A is a schematic perspective view of the substantial part of an optical pickup device according to a fifteenth embodiment of the present invention;

FIG. 21B is a schematic view for explaining the inclination adjustment of the semiconductor laser device of the fifteenth embodiment;

FIG. 22A is a schematic perspective view of the substantial part of an optical pickup device according to a sixteenth embodiment of the present invention;

FIG. 22B is a schematic view for explaining the inclination adjustment of the semiconductor laser device of the sixteenth embodiment;

FIG. 23A is a schematic perspective view of the substantial part of the semiconductor laser device of an optical pickup device according to a seventeenth embodiment of the present invention;

FIG. 23B is a schematic top view of the semiconductor laser device of the seventeenth embodiment;

FIG. 24A is a schematic perspective view of the substantial part of the semiconductor laser device of an optical pickup device according to an eighteenth embodiment of the present invention;

FIG. 24B is a schematic top view of the semiconductor laser device of the eighteenth embodiment;

FIG. 25A is a schematic perspective view of the substantial part of the semiconductor laser device of an optical pickup device according to a nineteenth embodiment of the present invention;

FIG. 25B is a schematic top view of the semiconductor laser device of the nineteenth embodiment;

FIG. 26A is a schematic perspective view of the substantial part of an optical pickup device according to a twentieth embodiment of the present invention;

FIG. 26B is a schematic view for explaining the inclination adjustment of the semiconductor laser device of the optical pickup device of the twentieth embodiment;

FIG. 26C is a schematic front view of the semiconductor laser device of the twentieth embodiment;

FIG. 26D is a schematic bottom view of the semiconductor laser device of the twentieth embodiment;

FIG. 27A is a schematic perspective view of the substantial part of an optical pickup device according to a twenty-first embodiment of the present invention;

FIG. 27B is a schematic view for explaining the inclination adjustment of the semiconductor laser device of the optical pickup device of the twenty-first embodiment;

FIG. 27C is a schematic front view of the semiconductor laser device of the twenty-first embodiment;

FIG. 27D is a schematic bottom view of the semiconductor laser device of the twenty-first embodiment;

FIG. 28 is a conceptual diagram of the basic structure of a conventional optical pickup device;

FIG. 29 is a basic structural view of the conventional semiconductor laser device;

FIG. 30 is a schematic perspective view of the LD chip of the conventional semiconductor laser device; and

FIG. 31 is a schematic perspective view of another conventional semiconductor laser device.

### DETAILED DESCRIPTION OF THE INVENTION

The semiconductor laser device of the present invention will be described in detail below by the embodiments shown in the drawings.

### First Embodiment

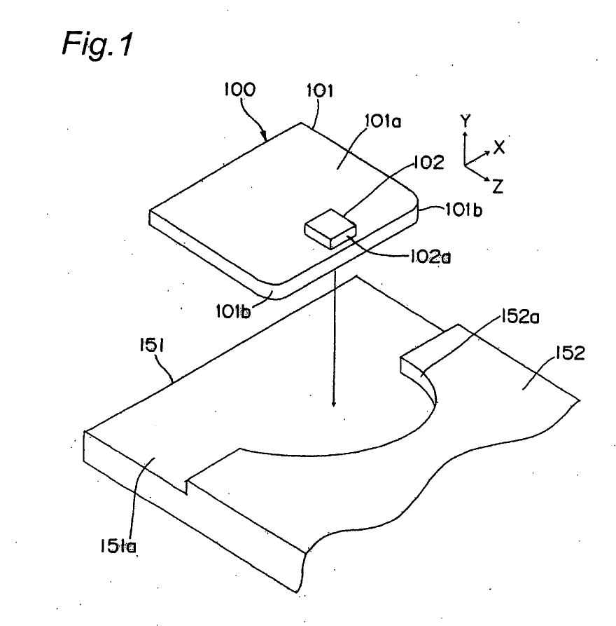

FIG. 1 shows a schematic diagram showing a substantial part of an optical pickup device according to the first embodiment of the present invention viewed obliquely from above.

The optical pickup device has a semiconductor laser device 100 and a housing 151. The housing 151 has a mounting surface 151a to which the semiconductor laser device 100 is attached.

The semiconductor laser device 100 has a roughly quadrangular plate shaped thin metal plate 101 and an LD chip 102. The thin metal plate 101 serves as one example of the metal plate and has a mounting surface 101a. The LD chip 102 serves as one example of the semiconductor laser element and has a front end surface 102a from which laser light is emitted.

The LD chip 102 is fixed to a front end portion of the mounting surface 101a of the thin metal plate 101 with use of a material of, for example, an indium or silver paste having a good thermal conductivity. Moreover, the layer thickness direction of the layer that constitutes the LD chip 102 is parallel to the Y-axis direction. That is, the crystal growth direction of the LD chip 102 is parallel to the Y-axis direction.

Radius portions 101b, as one example of the first turn guide mechanism, are formed at ends of an front edge portion of the thin metal plate 101 located on the side of the front end surface 102a of the LD chip 102. On the other hand, two roughly right-angled portions are formed at ends of a rear edge portion of the thin metal plate 101 located on the side opposite to the front end surface 102a.

A guide portion 152, which has an upper surface higher than a mounting surface 151a, is formed in the housing 151. The upper surface of the guide portion 152 is roughly parallel to the mounting surface 151a. Moreover, a curved surface 152a, which is one example of the second turn guide mechanism, is formed at the guide portion 152. The curved surface 152a is roughly perpendicular to the mounting surface 151a. Moreover, the guide portion 152 has a thickness smaller than the thickness of the thin metal plate 101. That is, the height of the upper surface of the guide portion 152 with respect to the mounting surface 151a is lower than the thickness of the thin metal plate 101.

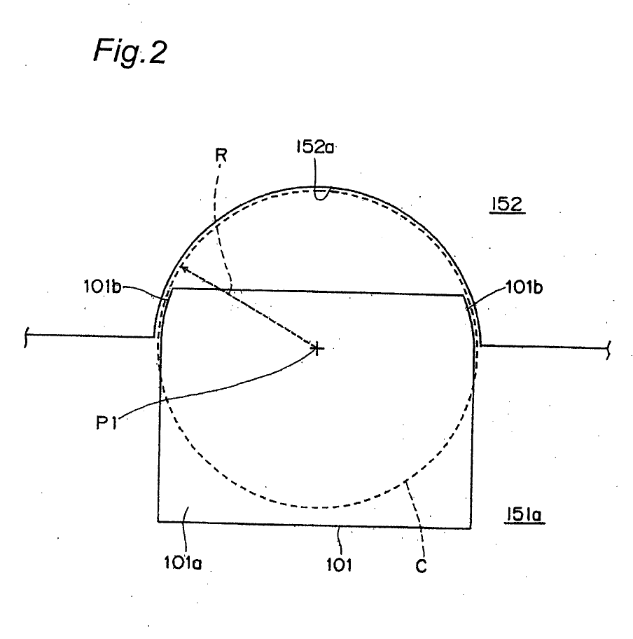

FIG. 2 shows a schematic view of the substantial part of the optical pickup device viewed from above. 125 A curvature radius of each edge of the radius portions 101b approximately equals to a radius R of a circle C centered at the light-emitting point P1 of the LD chip 102 in plan view. In other words, when the semiconductor laser device 100 is arranged in a prescribed position of the mounting surface 151a, the edges of the radius portions 101b are located roughly on the circular arc of the circle C centered at the light-emitting point P1 of the LD chip 102 in plan view.

A curvature radius of an edge of the curved surface 152a approximately equals to the radius R of the circle C centered at the light-emitting point P1 of the LD chip 102 in plan view. In other words, when the semiconductor laser device 100 is arranged in a prescribed position of the mounting surface 151a, the edge of the curved surface 152a roughly overlaps the circular arc of the circle C centered at the light-emitting point P1 of the LD chip 102 in plan view.

According to the optical pickup device of this construction, when the semiconductor laser device 100 is attached to the mounting surface 151a of the housing 151, the semiconductor laser device 100 is placed on the mounting surface 151a of the housing 151, and then, the radius portions 101b are brought in contact with the curved surface 152a. Thereafter, the radius portions 101b are slid under the state of contacting with the curved surface 152a. Thereby, the turn of the thin metal plate 101 is regulated by the curved surface 152a, and the thin metal plate 101 turns about the light-emitting point P1 of the LD chip 102 along a plane parallel to the mounting surface 101a with respect to the housing 151. Therefore, the inclination adjustment of the LD chip 102 in the direction of θ∥ is performed without causing any positional deviation of the light-emitting point P1 of the LD chip 102. Thus, a bad influence can be prevented from being exerted on the recording and reproduction characteristics of the information of the optical disk.

It is proper to conduct the inclination adjustment while measuring the light intensity distribution of the laser light from the front end surface 102a by a CCD camera or the like.

Moreover, after the inclination adjustment of the LD chip 102 in the direction of θ∥ is performed, it is proper to fix the semiconductor laser device 100 to the mounting surface 151a of the housing 151 with use of an adhesive of, for example, a photo-curable resin.

### Second Embodiment

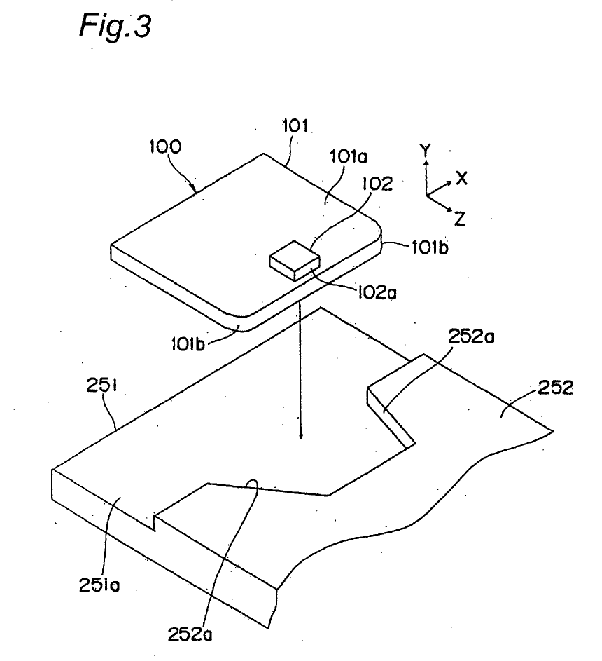

FIG. 3 shows a schematic view of an optical pickup device according to the second embodiment of the present invention viewed obliquely from above. In FIG. 3, the same components as those of the first embodiment shown in FIGS. 1 and 2 are denoted by the same reference numerals as those of the components in FIGS. 1 and 2 with no description provided therefor.

The optical pickup device has the semiconductor laser device 100 and a housing 251. The housing 251 has a mounting surface 251a to which the semiconductor laser device 100 is attached.

A guide portion 252, which has an upper surface higher than that of the mounting surface 251a, is formed in the housing 251. The guide portion 252 has an upper surface roughly parallel to the mounting surface 251a. Moreover, planar surfaces 252a of one example of the second turn guide mechanism are formed at the guide portion 252. The planar surfaces 252a are roughly perpendicular to the mounting surface 251a. Moreover, the guide portion 252 has a thickness smaller than the thickness of the thin metal plate 101. That is, the height of the upper surface of the guide portion 252 with respect to the mounting surface 251a is lower than the thickness of the thin metal plate 101.

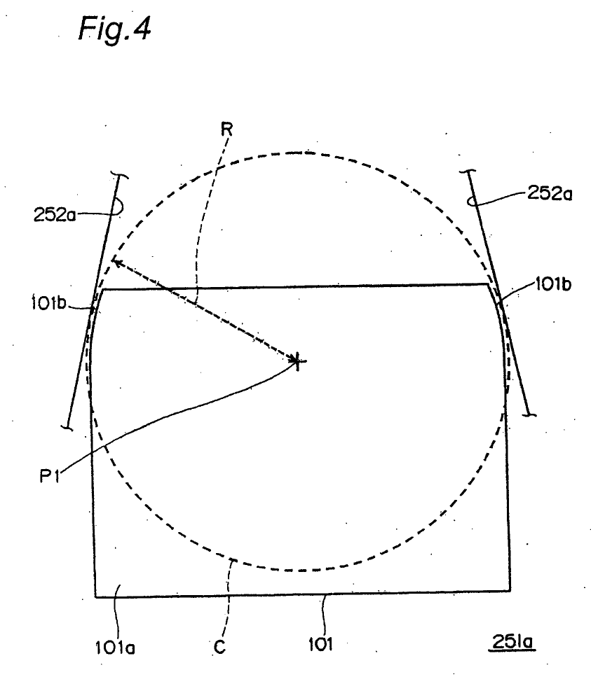

FIG. 4 shows a schematic view of the substantial part of the optical pickup device viewed from above.

When the semiconductor laser device 100 is arranged in a prescribed position of the mounting surface 251a, the planar surfaces 252a are located roughly on tangential lines to the edges of the radius portions 101b in plan view.

According to the optical pickup device of this construction, when the semiconductor laser device 100 is attached to the mounting surface 251a of the housing 251, the semiconductor laser device 100 is placed on the mounting surface 251a of the housing 251. Then, the radius portions 101b are brought in contact with the planar surfaces 252a, and thereafter, the radius portions 101b are slid under the state of contacting with the planar surfaces 252a. As a result, the turn of the thin metal plate 101 is regulated by the planar surfaces 252a, and the thin metal plate 101 turns about the light-emitting point P1 of the LD chip 102 along a plane parallel to the mounting surface 101a with respect to the housing 251. Therefore, the inclination adjustment of the LD chip 102 in the direction of θ∥ is performed without causing any positional deviation of the light-emitting point P1 of the LD chip 102. Thus, a bad influence can be prevented from being exerted on the recording and reproduction characteristics of the information of the optical disk.

Since the curved surface 152a has been used as one example of the second turn guide mechanism in the first embodiment, a fitting tolerance (clearance) has been required between the radius portions 101b and the curved surface 152a. That is, it is necessary for the curvature radius of the edges of the radius portions 101b to be made smaller than the curvature radius of the edges of the curved surface 152a. Therefore, when the inclination adjustment of the LD chip 102 in the direction of θ∥ is performed, the semiconductor laser device 100 disadvantageously rattles.

In contrast to this, the planar surfaces 252a are used as one example of the second turn guide mechanism in the present embodiment, and therefore, no fitting tolerance between the radius portions 101b and the planar surfaces 252a is necessary. With this arrangement, when the radius portions 101b are held against the planar surfaces 252a, no rattling of the semiconductor laser device 100 occurs during the inclination adjustment of the LD chip 102 in the direction of θ∥.

Therefore, the optical pickup device of the present embodiment can perform the inclination adjustment of the LD chip 102 in the direction of q∥ more accurately than the optical pickup device of the first embodiment. That is, the variation in the position of the light-emitting point P1 can be much more suppressed, which can provide an optical pickup device of satisfactory characteristics.

### Third Embodiment

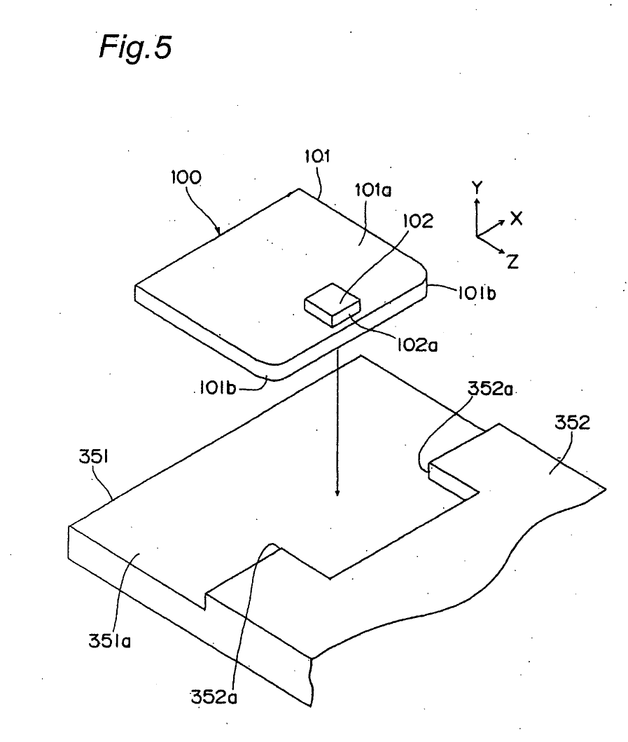

FIG. 5 shows a schematic view of the substantial part of an optical pickup device according to the third embodiment of the present invention viewed obliquely from above. In FIG. 5, the same components as those of the first embodiment shown in FIGS. 1 and 2 are denoted by the same reference numerals as those of the components in FIGS. 1 and 2 with no description provided therefor.

The optical pickup device has a semiconductor laser device 100 and a housing 351 that has a mounting surface 351a to which the semiconductor laser device 100 is attached.

A guide portion 352, which has an upper surface higher than that of the mounting surface 351a, is formed in the housing 351. The upper surface of the guide portion 352 is roughly parallel to the mounting surface 351a. Moreover, two roughly right-angled portions 352a as one example of the second angled portion are formed in the guide portion 352. Moreover, the guide portion 352 has a thickness smaller than the thickness of the thin metal plate 101. That is, the height of the upper surface of the guide portion 352 with respect to the mounting surface 351a is lower than the thickness of the thin metal plate 101.

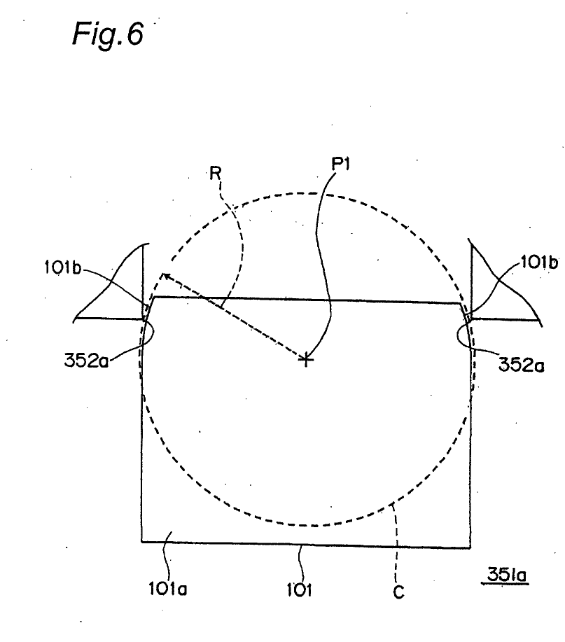

FIG. 6 shows a schematic view of the substantial part of the optical pickup device viewed from above.

When the semiconductor laser device 100 is placed in a prescribed position of the mounting surface 351a, a distance from the light-emitting point P1 of the LD chip 102 to the roughly right-angled portions 352a becomes approximately equal to a distance from the light-emitting point P1 of the LD chip 102 to the respective edges of the radius portions 101b. That is, the apexes of the roughly right-angled portions 352a roughly overlap arbitrary points on the circumference of the circle C centered at the light-emitting point P1 of the LD chip 102 in plan view.

According to the optical pickup device of this construction, when the semiconductor laser device 100 is attached to the mounting surface 251a of the housing 251, the semiconductor laser device 100 is placed on the mounting surface 251a of the housing 251, and then, the radius portions 101b are brought in contact with the roughly right-angled portions 352a. That is, the thin metal plate 101 is brought in contact with the guide portion 352 at two points. Thereafter, the radius portions 101b are slid under the state of contacting with the two roughly right-angled portions 352a of the guide portion 352. Thereby, the turn of the thin metal plate 101 is regulated by the roughly right-angled portions 352a, so that the thin metal plate 101 turns about the light-emitting point P1 of the LD chip 102 along a plane parallel to the mounting surface 101a with respect to the housing 351. Therefore, the inclination adjustment of the LD chip 102 in the direction of q∥ is performed without causing any positional deviation of the light-emitting point P1 of the LD chip 102. Thus, a bad influence can be prevented from being exerted on the recording and reproduction characteristics of the information of the optical disk.

Also, in the optical pickup device of the present embodiment, when the radius portions 101b are held against the roughly right-angled portions 352a as in the case of the optical pickup device of the second embodiment, no rattling of the semiconductor laser device 100 occurs during the inclination adjustment of the LD chip 102 in the direction of q∥.

Moreover, in the optical pickup device of the present embodiment, it is required to control only the positional accuracy of the two roughly right-angled portions 352a. In other words, it is required to control the housing 351 such that the apexes of the two roughly right-angled portions 352a roughly overlap arbitrary points on the circumference of the circle C in plan view. Therefore, it is easier to control the accuracy of the housing 351 than in the optical pickup devices of the second embodiment. Therefore, the manufacturing cost of the housing 351 of the optical pickup device of the present embodiment may be further reduced than that of the optical pickup device of the second embodiment.

### Fourth Embodiment

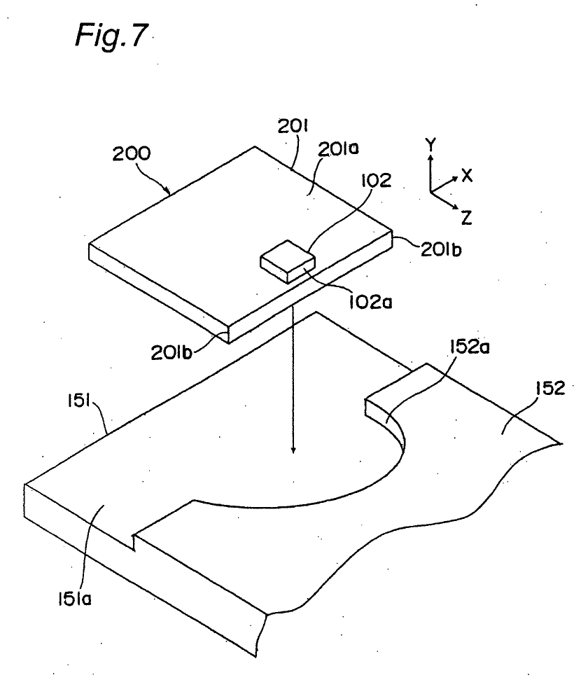

FIG. 7 shows a schematic view of the substantial part of an optical pickup device according to the fourth embodiment of the present invention viewed obliquely from above. Moreover, the same components as those of the first embodiment shown in FIGS. 1 and 2 are denoted by the same reference numerals as those of the components in FIGS. 1 and 2 with no description provided therefor.

The optical pickup device has a semiconductor laser device 200 and a housing 151 that has a mounting surface 151a to which the semiconductor laser device 200 is attached.

The semiconductor laser device 200 has a roughly quadrangular plate shaped thin metal plate 201, as one example of the metal plate, which has a mounting surface 201a. The thin metal plate 201 has a thickness greater than the thickness of the guide portion 152. That is, the thickness of the thin metal plate 201 is thicker than the height of the upper surface of the guide portion 152 with respect to the mounting surface 151a. Moreover, two roughly right-angled portions 201b, as one example of the first angled portion, are formed at ends of the edge portion of the thin metal plate 201 located on the side of the front end surface 102a (on the side of the guide portion 152). On the other hand, two roughly right-angled portions are also formed at ends of the edge portion of the thin metal plate 101 on the side opposite to the front end surface 102a.

When the semiconductor laser device 200 is arranged in a prescribed position of the mounting surface 151a, a distance from the light-emitting point of the LD chip 102 to the roughly right-angled portions 201b becomes approximately equal to a distance from the light-emitting point of the LD chip 102 to the curved surface 152a. That is, the apexes of the roughly right-angled portions 201b roughly overlap arbitrary points on the circumference of a circle centered at the light-emitting point of the LD chip 102 in plan view.

In the optical pickup device of this construction, when the semiconductor laser device 200 is attached to the mounting surface 151a of the housing 151, the semiconductor laser device 200 is placed on the mounting surface 151a of the housing 151. Then, the roughly right-angled portions 201b are brought in contact with the curved surface 152a. That is, the thin metal plate 201 is brought in contact with the guide portion 152 at two points. Thereafter, the two roughly right-angled portions 201b are slid under the state of contacting with the curved surface 152a. Thereby, the turn of the thin metal plate 201 is regulated by the curved surface 152a, and the thin metal plate 201 is turned about the light-emitting point of the LD chip 102 along a plane parallel to the mounting surface 201a with respect to the housing 151. Therefore, the inclination adjustment of the LD chip 102 in the direction of q∥ is performed without causing any positional deviation of the light-emitting point of the LD chip 102. Thus, a bad influence can be prevented from being exerted on the recording and reproduction characteristics of the information of the optical disk.

Moreover, the radius portions 101b are not formed at ends of the edge portion of the thin metal plate 201 unlike the optical pickup device of the first embodiment. Therefore, in the optical pickup device of the present embodiment, the thin metal plate 201 has a larger contact area with respect to the mounting surface 151a of the housing 151 than that of the optical pickup device of the first embodiment. Therefore, in the optical pickup device of the present embodiment, the heat radiation property of the LD chip 102 is further improved than in the optical pickup device of the first embodiment.

### Fifth Embodiment

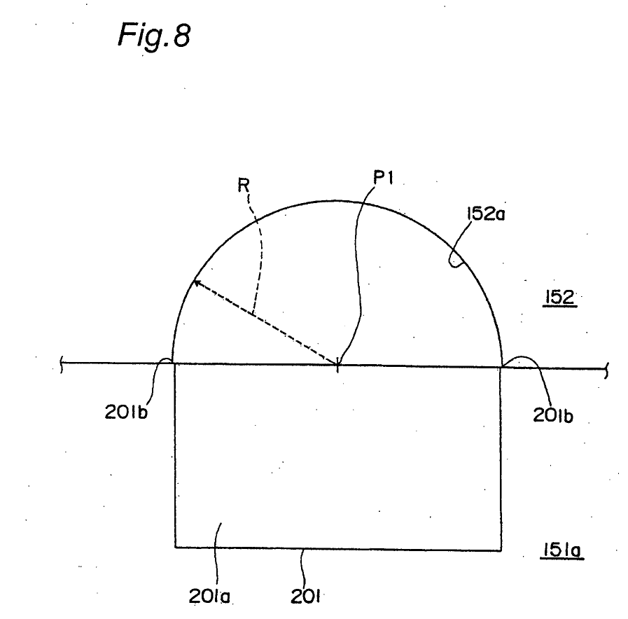

In the case that the light-emitting point P1 of the LD chip 102 is located in the neighborhood of the front end portion of the thin metal plate 201 in the optical pickup device of the fourth embodiment, the two roughly right-angled portions 201b cannot slide on the curved surface 152a as shown in FIG. 8. Therefore, the turn of the thin metal plate 101 cannot be regulated by the curved surface 152a. As the result, there is a disadvantage that the position of the light-emitting point P1 of the LD chip 102 deviates from the prescribed position during the inclination adjustment of the LD chip 102 in the direction of q∥.

The disadvantage can be avoided by the optical pickup device of the fifth embodiment of the present invention.

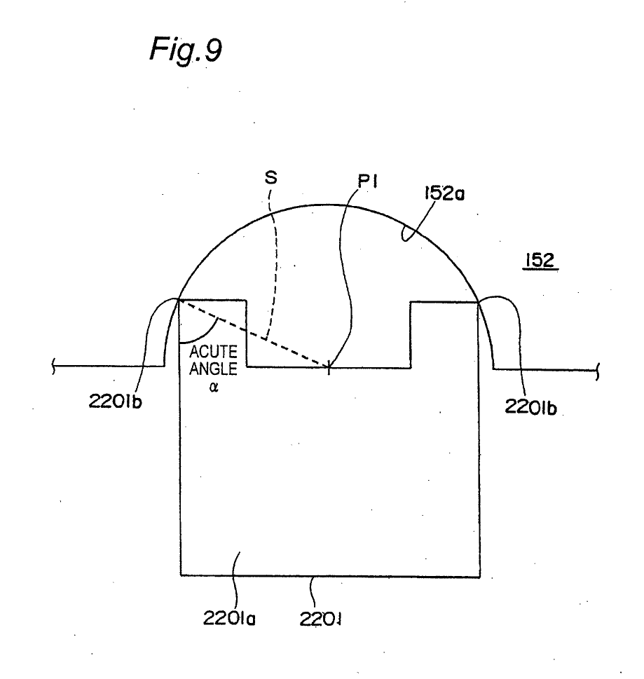

FIG. 9 shows a schematic view of the substantial part of an optical pickup device according to the fifth embodiment of the present invention viewed from above.

The semiconductor laser device of the optical pickup device has a thin metal plate 2201 as one example of the metal plate that has a mounting surface 2201a. The thin metal plate 2201 has a width smaller than the length two times the curvature radius of the curved surface 152a. Moreover, two roughly right-angled portions 2201b, as one example of the first angled portion, are formed at ends of the front edge portion of the thin metal plate 2201 located on the side of the guide portion 152. On the other hand, two roughly right-angled portions are also formed at ends of the rear edge portion of the thin metal plate 2201 located on the side opposite to the guide portion 152. Then, a cut is formed at the front edge portion of the thin metal plate 2201 located between the roughly right-angled portions 2201b. A straight line S, which extends from the light-emitting point P1 to the apex of the roughly right-angled portion 2201b, intersects at an acute angle α (smaller than 90°) with the side surface of the thin metal plate 2201.

According to the optical pickup device of this construction, by making the straight line S intersect at the acute angle α with the side surface of the thin metal plate 2201, the thin metal plate 2201 can be brought in contact with the guide portion 152 at two points. That is, the two roughly right-angled portions 2201b can slide on the curved surface 152a. Therefore, the turn of the thin metal plate 2201 can be regulated by the curved surface 152a.

Moreover, since the cut is formed at the edge portion of the thin metal plate 2201 located between the roughly right-angled portions 2201b, the LD chip mounting position of the semiconductor laser device can be set around the front end surface of the thin metal plate 2201 when the straight line S intersects at the acute angle α with the side surface of the thin metal plate 2201.

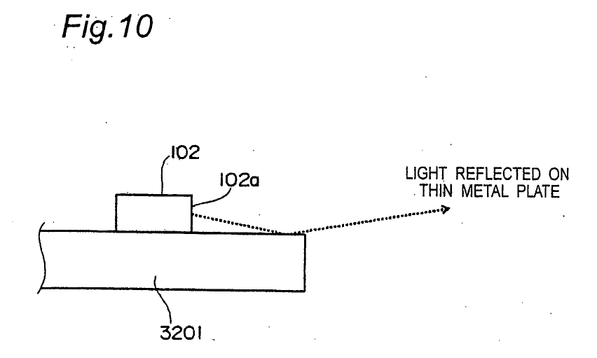

Placing the LD chip mounting position of the semiconductor laser device in the neighborhood of the front end surface of the thin metal plate 2201 advantageously allows the light-emitting point P1 to be placed forward. Thus, the laser light emitted from the front end surface 102a of the LD chip 102 is not reflected on the surface of a thin metal plate 3201 unlike in the case of FIG. 10. That is, the so-called ripple light that disorders the laser light is not generated.

The conditions of the present embodiment may be used for the fourth embodiment. That is, the straight line, which extends through each of the apexes of the roughly right-angled portions 201b and the neighborhood of the light-emitting point of the LD chip 102, may intersect the side surface of the thin metal plate 201 at an acute angle in the fourth embodiment.

### Sixth Embodiment

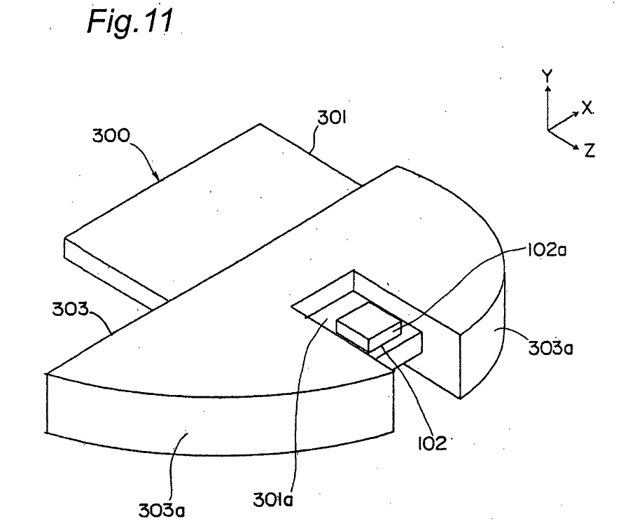

FIG. 11 shows a schematic view of a semiconductor laser device 300 provided for the optical pickup device according to the sixth embodiment of the present invention viewed obliquely from above. In FIG. 11, the same components as those of the first embodiment shown in FIGS. 1 and 2 are denoted by the same reference numerals as those of the components in FIGS. 1 and 2 with no description provided therefor.

The semiconductor laser device 300 has a thin metal plate 301, as one example of the metal plate, which has a mounting surface 301a. An LD chip 102 is fixed to the mounting surface 301a of the thin metal plate 301 with use of a material of, for example, an indium or silver paste having a good thermal conductivity. Moreover, a resin part 303 is formed integrally with the front end portion of the thin metal plate 301.

Two radius portions 303a, as one example of the first turn guide mechanism, are formed at the edge portion (front end portion) of the resin part 303 located on the side of the front end surface 102a. The radius portions 303a are obtained by molding the resin part 303 integrally with the thin metal plate 301. This arrangement allows the radius portions 303a to improve in accuracy of the shape thereof. The edges of the radius portions 303a roughly overlap the circular arc of a circle centered at the light-emitting point of the LD chip 102 in plan view.

For example, a thin metal plate as in, for example, the first embodiment has its external shape usually formed by being punched out by a stamping die. Therefore, the edge tends to round the edge or generate burrs due to the punching. Thus, to secure the external accuracy of the thin metal plate, a considerable time is required for the punching. Also, it is required to improve the accuracy of the stamping die for punching.

In contrast to this, a die for resin molding makes it possible to manufacture the resin part 303 with an accurate external shape, and therefore, a turn mechanism with good accuracy can be obtained. Moreover, it is advantageous that the resin part 303 has a higher degree of freedom for shape than that of the thin metal plate.

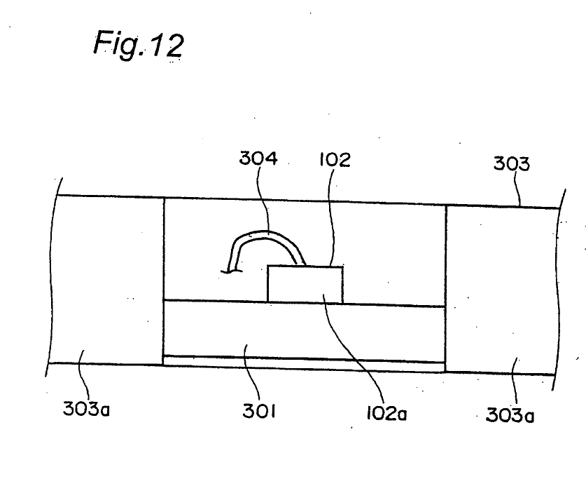

FIG. 12 shows a schematic view of the semiconductor laser device 300 viewed from the front.

According to the semiconductor laser device, the resin part 303 has a shape that surrounds three surfaces of the LD chip 102. That is, the resin part 303 has the surfaces that face the rear end surface and the two side surfaces of the LD chip 102. With this arrangement, the resin part 303 concurrently has a function to protect the LD chip 102.

Moreover, the upper surface (surface on the opposite side of the thin metal plate 301) of the resin part 303 is higher than the upper surface of the LD chip 102, and also higher than the uppermost portion (portion on the opposite side of the thin metal plate 301) of a wire bonding wire 304 connected to the upper surface of the LD chip 102. This arrangement largely reduces the risk of damaging the LD chip 102 and the wire bonding wire 304 as the result of erroneously touching the LD chip 102 and the wire bonding wire 304 when the semiconductor laser device is handled in the manufacturing process of the optical pickup device.

The optical pickup device of the present embodiment may have a housing as described in connection with the first through fifth embodiments.

When the resin part 303 is formed of an insulative resin material, it is possible to cause the static breakdown of the LD chip 102 as a consequence of the electrification of the resin part 303 when the semiconductor laser device 300 is handled in the manufacturing process of the optical pickup device. Therefore, the resin part 303 should better be formed of a resin material that has electrical conductivity.

Moreover, the resin part 303 may be formed of a resin material that contains highly thermally conductive metal powder or metallic particles of copper, aluminum, iron or the like. The resin part 303 made of the above-stated resin material can prevent electrification of the resin part 303. Moreover, in the case, the thermal conductivity of the resin part 303 is also improved. Therefore, the resin part containing the highly thermally conductive metal powder or particles is useful in a semiconductor laser device of a high optical power that requires a heat radiation property.

### Seventh Embodiment

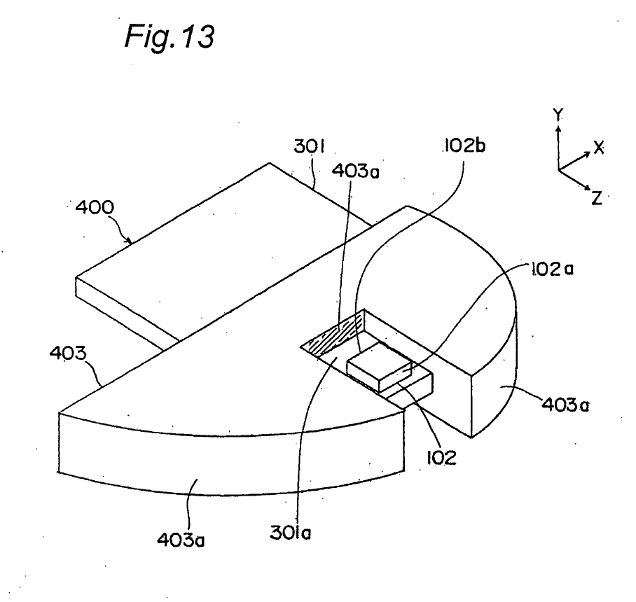

FIG. 13 shows a schematic view of a semiconductor laser device 400 provided for the optical pickup device according to the seventh embodiment of the present invention viewed obliquely from above. In FIG. 13, the same components as those of the sixth embodiment shown in FIG. 11 are denoted by the same reference numerals as those of the components in FIG. 11 with no description provided therefor.

The semiconductor laser device 400 has a resin part 403 formed integrally with the front end portion of the thin metal plate 301.

Two radius portions 403a, as one example of the first turn guide mechanism, are formed at the edge portion (front end portion) of the resin part 403 located on the side of the front end surface 102a. The radius portions 403a are obtained by molding the resin part 403 integrally with the thin metal plate 301. With this arrangement, the radius portion 403a can be improved in accuracy of the shape thereof. The edges of the radius portions 403a roughly overlap the circular arc of a circle centered at the light-emitting point of the LD chip 102 in plan view.

Moreover, a surface 403b that faces the rear end surface 102b of the LD chip 102 is formed on the resin part 403. The surface 403b is painted in black.

According to the semiconductor laser device 400 of this construction, a laser light is emitted also from the rear end surface 102b of the LD chip 102. If the rear end surface 102b of the LD chip 102 can be manufactured to have one hundred percent reflectance, no laser light is emitted from the rear end surface 102b of the LD chip 102. However, it is technically difficult to make the rear end surface 102b of the LD chip 102 have one hundred percent reflectance. Thus, laser light is also emitted from the rear end surface 102b of the LD chip 102. It is concerned that the laser light emitted from the rear end surface 102b of the LD chip 102 might be reflected on the surface 403b of the resin part 403 to enter the inside of the optical pickup device and become stray light. However, since the surface 403b that faces the rear end surface 102b of the LD chip 102 is painted in black, which reduces the reflectance of the surface 403b of the resin part 403. Therefore, the laser light emitted from the rear end surface 102b of the LD chip 102 is substantially prevented from entering the inside of the optical pickup device and from becoming stray light.

The stray light may be mixed with the signal light from the optical disk, which becomes a cause to deteriorate the characteristics of the optical pickup device.

Although only the surface 403b of the resin part 403 has been painted in black in this embodiment, the entire surface of the resin part 403 may be painted in black.

Moreover, the resin material itself of the resin part 403 may be black. In other words, the resin part 403 may be made of a black resin material.

In the embodiment, the above-stated surface 403b has been used for prevention of the generation of stray light. However, instead of the surface 403b, it is acceptable to use a light scattering surface which has minute undulations of about several tens to several hundreds of micrometers. The light scattering surface formed on the resin part 403 can scatter the laser light emitted from the rear end surface 102b of the LD chip 102. Thus, the laser light emitted from the rear end surface 102b of the LD chip 102 can be prevented from entering the inside of the optical pickup device, and therefore from becoming stray light.

The light scattering surface can easily be formed merely by using a resin molding die that has minute undulations on its surface. Thereby, the effect of preventing the generation of stray light can be obtained without increasing the manufacturing cost of the semiconductor laser device 400.

It is preferable that the surface of the radius portion 403a should not be the light scattering surface, but a smooth surface without the minute undulations such that the rotational adjustment of the LD chip 102 may be smoothly performed. That is, the surface of the radius portion 403a should preferably have a much smaller amount of undulations than the surface of the light scattering surface.

### Eighth Embodiment

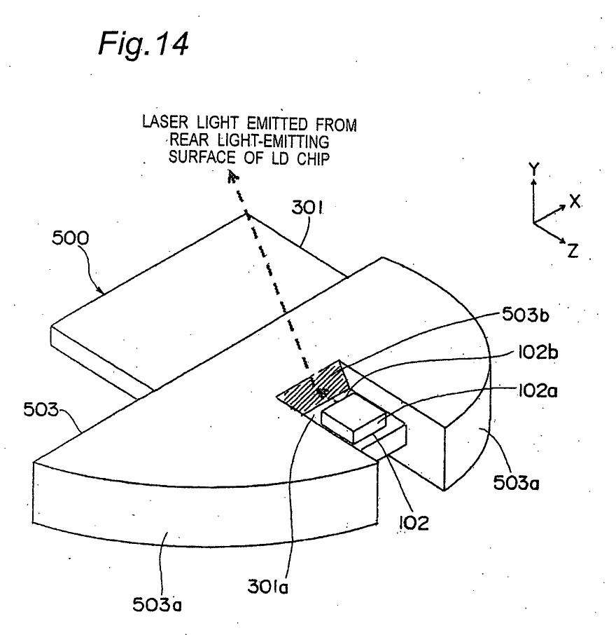

FIG. 14 shows a schematic view of a semiconductor laser device 500 provided for the optical pickup device according to the eighth embodiment of the present invention viewed obliquely from above. In FIG. 14, the same components as those of the sixth embodiment shown in FIG. 11 are denoted by the same reference numerals as those of the components in FIG. 11 with no description provided therefor.

The semiconductor laser device 500 has a resin part 503 formed integrally with the front end portion of the thin metal plate 301.

Two radius portions 503a, as one example of the first turn guide mechanism, are formed at the edge portion (front end portion) of the resin part 503 located on the side of the front end surface 102a. The radius portions 503a are obtained by molding the resin part 503 integrally with the thin metal plate 301. With this arrangement, the radius portions 503a can be improved in accuracy of the shape thereof. The edges of the radius portions 503a roughly overlap the circular arc of a circle centered at the light-emitting point of the LD chip 102 in plan view.

A surface 503b that faces the rear end surface 102b of the LD chip 102 is formed on the resin part 503. The surface 503b is inclined with respect to the optical axis of the laser light emitted from the rear end surface 102b of the LD chip 102.

According to the semiconductor laser device 500 of this construction, the laser light emitted from the rear end surface 102b of the LD chip 102 is guided to the outside of the semiconductor laser device because the surface 503b that faces the rear end surface 102b of the LD chip 102 is inclined with respect to the optical axis of the laser light emitted from the rear end surface 102b of the LD chip 102. Thus, the laser light emitted from the rear end surface 102b of the LD chip 102 is prevented from entering the inside of the optical pickup device and from becoming stray light.

The surface 503b of the resin part 503 is easily formed merely by using a resin molding die that has a shape corresponding to the shape of the surface 503b. Thereby, the effect of preventing the generation of stray light can be obtained without increasing the manufacturing cost of the semiconductor laser device 500.

### Ninth Embodiment

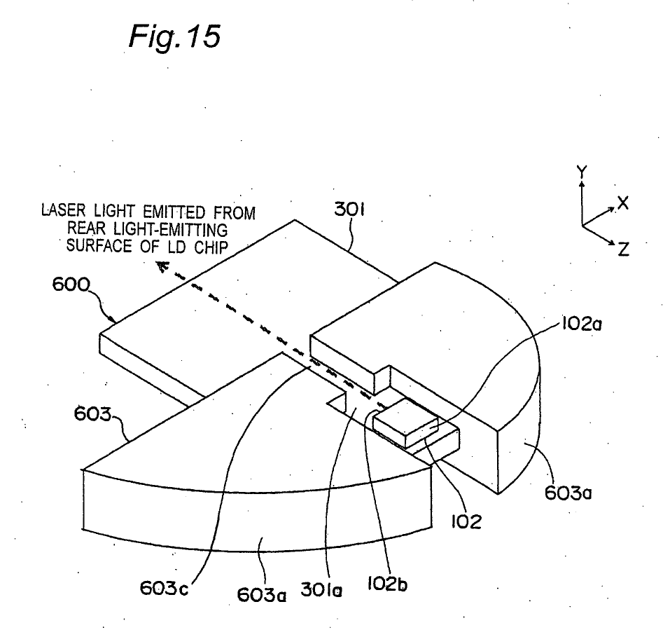

FIG. 15 shows a schematic view of a semiconductor laser device 600 provided for the optical pickup device according to the ninth embodiment of the present invention viewed obliquely from above. In FIG. 15, the same components as those of the sixth embodiment shown in FIG. 11 are denoted by the same reference numerals as those of the components in FIG. 11 with no description provided therefor.

The semiconductor laser device 600 has a resin part 603 formed integrally with the front end portion of the thin metal plate 301.

Two radius portions 603a, as one example of the first turn guide mechanism, are formed at the edge portion (front end portion) of the resin part 603 located on the side of the front end surface 102a. The radius portions 603a are obtained by molding the resin part 603 integrally with the thin metal plate 301. With this arrangement, the radius portions 603a can be improved in accuracy of the shape thereof. The edges of the radius portions 603a roughly overlap the circular arc of a circle centered at the light-emitting point of the LD chip 102 in plan view.

Moreover, a cut 603c is formed at a portion of the resin part 603 that should face the rear end surface 102b of the LD chip 102.

According to the semiconductor laser device 600 of this construction, laser light emitted from the rear end surface 102b of the LD chip 102 is guided to the outside of the semiconductor laser device because the cut 603c is at a portion of the resin part 603 that faces the rear end surface 102b of the LD chip 102. Thus, the laser light emitted from the rear end surface 102b of the LD chip 102 is prevented from entering the inside of the optical pickup device and from becoming stray light.

The cut 603c of the resin part 603 is easily formed merely by using a resin molding die that has a shape corresponding to the shape of the cut 603c. Thereby, the effect of preventing the generation of stray light can be obtained without increasing the manufacturing cost of the semiconductor laser device 600.

### Tenth Embodiment

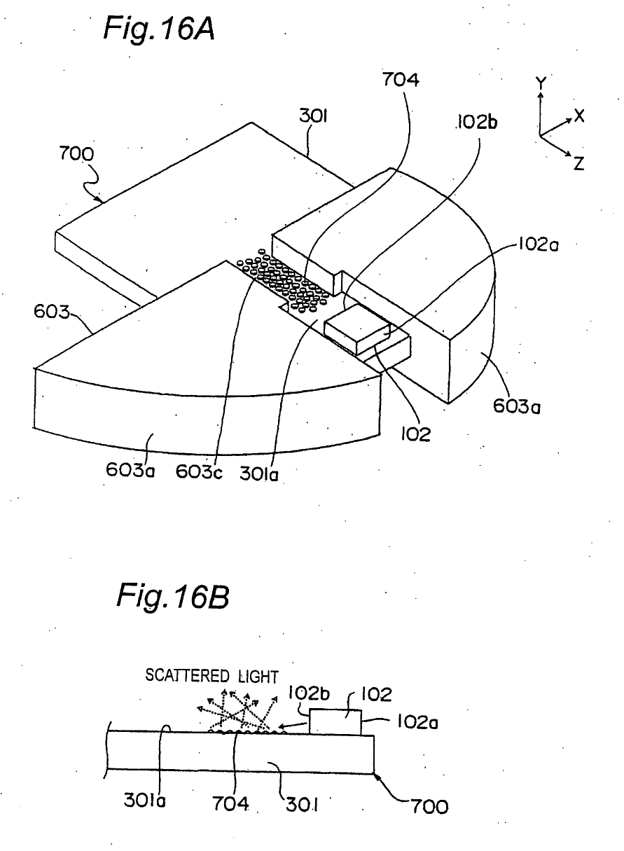

FIG. 16A shows a schematic view of a semiconductor laser device 700 provided for the optical pickup device according to the tenth embodiment of the present invention viewed obliquely from above. FIG. 16B shows a schematic sectional view of the substantial part of the semiconductor laser device 700. In FIGS. 16A and 16B, the same components as those of the ninth embodiment shown in FIG. 15 are denoted by the same reference numerals as those of the components in FIG. 15 with no description provided therefor.

As shown in FIG. 16A, the semiconductor laser device 700 has a resin part 603 formed integrally with the front end portion of the thin metal plate 301. A plurality of projections 704 as one example of the light scattering means for scattering the laser light emitted from the rear end surface 102b of the LD chip 102 are formed on the mounting surface 301a exposed by the cut 603c of the resin part 603. The plurality of projections 704 are constituted of a resin material.

According to the semiconductor laser device 700 of this construction, the laser light emitted from the rear end surface 102b of the LD chip 102 is guided to the outside of the semiconductor laser device by being scattered by the projections 704 as shown in FIG. 16B. This is because the projections 704 are formed on the surface 301a exposed by the cut 603c of the resin part 603. Thus, the laser light emitted from the rear end surface 102b of the LD chip 102 is prevented from entering the inside of the optical pickup device and from becoming stray light.

Moreover, the laser light emitted from the rear end surface 102b of the LD chip 101 is scattered in a wide range by the projections 704. Therefore, the light scattered by the projections 704 prevents light from concentrating in a specific direction and from becoming stray light. When the optical pickup device is reduced in size, it is particularly useful that the light scattered by the projections 704 is not concentrated in a specific direction.

Moreover, the projections 704 is easily formed concurrently with the resin part 603 merely by using a resin molding die that has a shape corresponding to the shape of the projections 704. Thereby, the effect of preventing the generation of stray light can be obtained without increasing the manufacturing cost of the semiconductor laser device 700.

Although the projections 704 have not been painted in the embodiment, the projections 704 may be painted in black.

In the embodiment, the plurality of projections 704 have been formed on the surface 301a exposed by the cut 603c of the resin part 603. However, a black paint may be applied to the mounting surface 301a without forming the projections 704 on the surface 301a. When the mounting surface 301a is painted in black, the mounting surface 301a makes it possible to obtain an effect similar to that of the seventh embodiment. Moreover, in the case, the color and the pattern of the painting of the mounting surface 301a is freely changed by using, for example, an ink-jet technology. Therefore, a variety of stray light preventing arrangements can be achieved at lower cost than when the projections 704 are formed. Moreover, the color and the pattern of the painting of the mounting surface 301a are freely changed. Therefore, the optimal scattering can be obtained by the mounting surface 301a in a different optical pickup device.

In the embodiment, the plurality of projections 704 have been formed on the surface 301a that is exposed by the cut 603c of the resin part 603. However, it is acceptable only to provide a stain finish on the mounting surface 301a without forming the projections 704 thereon.

Although the projections 704 have been formed of the resin material in the embodiment, the projections 704 may be formed of a metallic material. For example, the projections 704 may be formed of part of the thin metal plate 301.

### Eleventh Embodiment

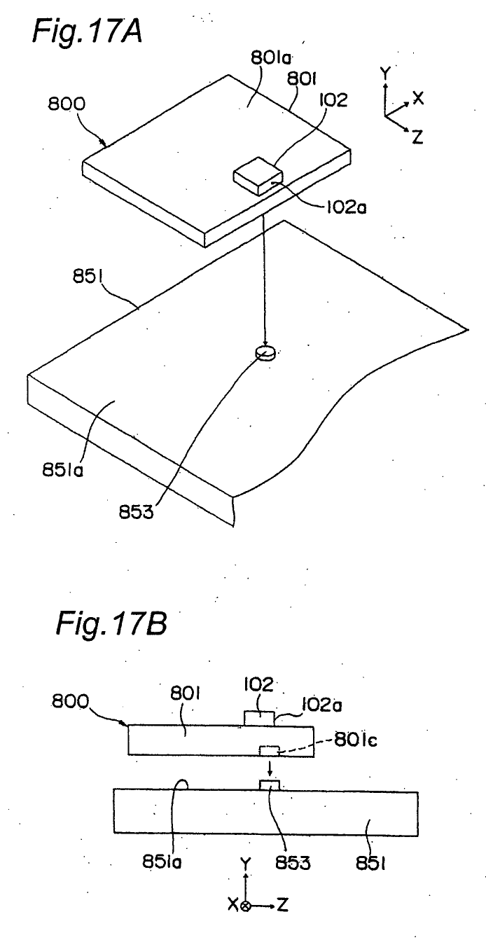

FIG. 17A shows a schematic view of the substantial part of an optical pickup device according to the eleventh embodiment of the present invention viewed obliquely from above. FIG. 17B shows a schematic view for explaining the inclination adjustment of a semiconductor laser device 800 provided for the optical pickup device.

As shown in FIG. 17A, the optical pickup device has a semiconductor laser device 800 and a housing 851 having a mounting surface 851a to which the semiconductor laser device 800 is attached.

The semiconductor laser device 800 has a roughly quadrangular plate shaped thin metal plate 801 and an LD chip 102. The thin metal plate 801 serves as one example of the metal plate and has a mounting surface 801a. The LD chip 102 serves as one example of the semiconductor laser device and has a front end surface 102a from which laser light is emitted.

The LD chip 102 is fixed to a front end portion of the mounting surface 801a of the thin metal plate 801 with use of a material of, for example, an indium or silver paste having a good thermal conductivity. With this arrangement, the light-emitting point of the LD chip 102 is located in the neighborhood of the front end surface of the thin metal plate 801. Moreover, the layer thickness direction of the layer that constitutes the LD chip 102 is parallel to the Y-axis direction. That is, the crystal growth direction of the LD chip 102 is parallel to the Y-axis direction.

As shown in FIG. 17B, a roughly cylindrical recess 801c, as one example of the first turn guide mechanism, is formed on the back surface (surface on the side opposite to the LD chip 102) of the thin metal plate 801. The recess 801c is aligned with the light-emitting point of the LD chip 102. In other words, the recess 801c is located below the light-emitting point of the LD chip 102. In other words, the sidewall surface, i.e., the circumferential surface of the recess 801c roughly overlaps the circumference of a circle centered at the light-emitting point of the LD chip 102 in plan view. The recess 801c is obtained by directly processing the thin metal plate 801.

A roughly columnar projection 853, as one example of the second turn guide mechanism, is formed on the mounting surface 851a of the housing 851. The side surface, i.e., the circumferential surface of the projection 853 roughly overlaps the circumference of a circle centered at the light-emitting point of the LD chip 102 in plan view. Moreover, the projection 853 can be fit in the recess 801c of the thin metal plate 801. The height of the projection 853c is approximately equal to the depth of the recess 801c.

According to the optical pickup device of this construction, when the semiconductor laser device 800 is attached to the mounting surface 851a of the housing 851, the projection 853 is fit in the recess 801c, and thereafter, the thin metal plate 801 is turned along a plane parallel to the mounting surface 801a. Thereby, the thin metal plate 801 is turned about the light-emitting point of the LD chip 102 along a plane parallel to the mounting surface 801a. Therefore, the inclination adjustment of the LD chip 102 in the direction of q∥ is performed without causing any positional deviation of the light-emitting point of the LD chip 102. Thus, a bad influence can be prevented from being exerted on the recording and reproduction characteristics of the information of the optical disk.

It is proper to perform the inclination adjustment while measuring the light intensity distribution of the laser light from the front end surface 102a by a CCD camera or the like.

Moreover, after the inclination adjustment of the LD chip 102 in the direction of q∥ is performed, it is proper to fix the semiconductor laser device 800 to the mounting surface 851a of the housing 851 with use of an adhesive of, for example, a photo-curable resin.

In the eleventh embodiment, the recess 801c, as one example of the first turn guide mechanism, has been formed at the thin metal plate 801. However, it is also acceptable to form a recess, as one example of the first turn guide mechanism, at the resin part formed integrally with the thin metal plate 801. The recess of the resin part, which can be formed by a resin molding die, can therefore be formed with accuracy higher than that of the recess of the thin metal plate. Therefore, forming the recess makes it possible to improve the rotational accuracy of the thin metal plate 801 and also to improve the degree of freedom of the shape of the recess.

### Twelfth Embodiment

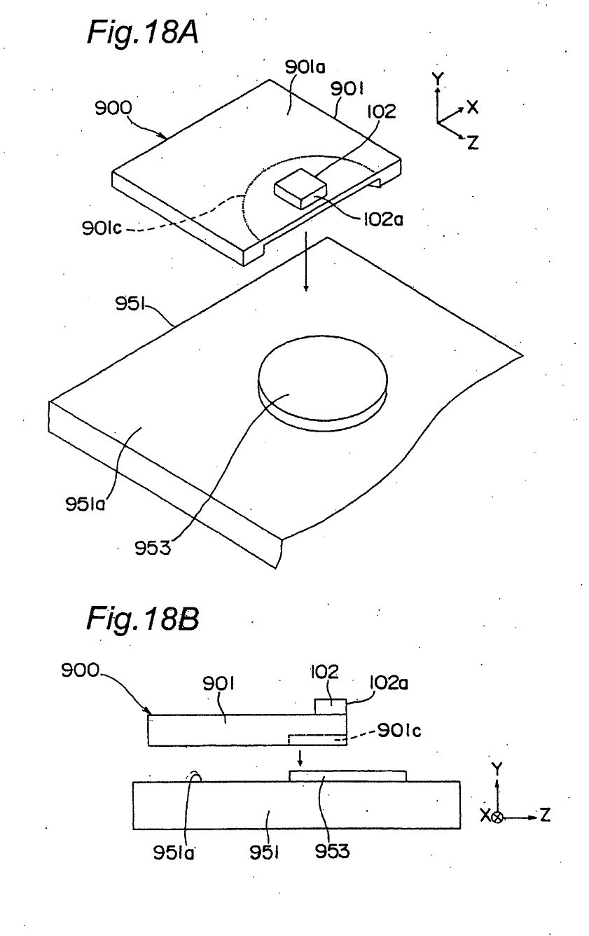

FIG. 18A shows a schematic view of the substantial part of an optical pickup device of the twelfth embodiment of the present invention viewed obliquely from above. FIG. 18B shows a schematic view for explaining the inclination adjustment of a semiconductor laser device 900 provided for the optical pickup device.

As shown in FIG. 18A, the optical pickup device has the semiconductor laser device 900 and a housing 951 that has a mounting surface 951a to which the semiconductor laser device 900 is attached.

The semiconductor laser device 900 has a roughly quadrangular plate shaped thin metal plate 901 and an LD chip 102. The thin metal plate 901 serves as one example of the metal plate and has a mounting surface 901a. The LD chip 102 serves as one example of the semiconductor laser element and has a front end surface 102a from which laser light is emitted.

The LD chip 102 is fixed to the front end portion of the mounting surface 901a of the thin metal plate 901 with use of a material of, for example, an indium or silver paste having a good thermal conductivity. With this arrangement, the light-emitting point of the LD chip 102 is located in the neighborhood of the front end surface of the thin metal plate 901. Moreover, the layer thickness direction of the layer that constitutes the LD chip 102 is parallel to the Y-axis direction. That is, the crystal growth direction of the LD chip 102 is parallel to the Y-axis direction.

A roughly semicircular plate shaped recess 901c, as one example of the first turn guide mechanism, is formed on the back surface (surface opposite to the LD chip 102) of the thin metal plate 901. The sidewall surface, i.e., the curved surface of the recess 901c roughly overlaps the circular arc of a circle centered at the light-emitting point of the LD chip 102 in plan view. Moreover, the light-emitting point of the LD chip 102 is above the center of the recess 901c. Specifically, the center point of the roughly semicircular surface of the recess 901c roughly overlaps the light-emitting point of the LD chip 102 on the side of the LD chip 102. Moreover, the recess 901c has an open portion on the side of the front end surface 102a of the LD chip 102. That is, the front end portion of the recess 901c is open. The recess 901c is obtained by directly processing the thin metal plate 901.

A roughly disk-shaped projection 953, as one example of the second turn guide mechanism, is formed on the mounting surface 951a of the housing 951. The sidewall surface, i.e., the circumferential surface of the projection 953 roughly overlaps the circumference of a circle centered at the light-emitting point of the LD chip 102 in plan view. Moreover, the projection 953 can be fit in the recess 901c of the thin metal plate 901. The height of the projection 953c is approximately equal to the depth of the recess 901c.

According to the optical pickup device of this construction, when the semiconductor laser device 900 is attached to the mounting surface 951a of the housing 951, the projection 953 is fit in the recess 901c as shown in FIG. 18B. Thereafter, the thin metal plate 901 is turned along a plane parallel to the mounting surface 901a with respect to the housing 951. Then, the thin metal plate 901 is turned about the light-emitting point of the LD chip 102 along a plane parallel to the mounting surface 901a with respect to the housing 951. Therefore, the inclination adjustment of the LD chip 102 in the direction of q∥ is performed without causing any positional deviation of the light-emitting point of the LD chip 102. Thus, a bad influence can be prevented from being exerted on the recording and reproduction characteristics of the information of the optical disk.

Moreover, since the recess 901c has the open portion on the side of the front end surface 102a of the LD chip 102, it is easy to form the recess at the front end portion of the back surface of the thin metal plate 901 and to produce it with high accuracy.

The inclination adjustment is properly performed while measuring the light intensity distribution of the laser light from the front end surface 102a by a CCD camera or the like.

Moreover, after the inclination adjustment of the LD chip 102 in the direction of q∥ is performed, it is proper to fix the semiconductor laser device 900 to the mounting surface 951a of the housing 951 with use of an adhesive of, for example, a photo-curable resin.

In the twelfth embodiment, the roughly disk-shaped projection 953 has been formed on the mounting surface 951a of the housing 951. However, it is acceptable to form, for example, a roughly quadrangular plate shaped or roughly pentagonal plate shaped projection on the mounting surface 951a of the housing 951. That is, the projection formed on the mounting surface 951a of the housing 951 is only required to have a shape such that the projection can come in contact with the curved surface of the recess 901c at two points.

When the projection that can come in contact with the curved surface of the recess 901c at two points is formed on the mounting surface 951a of the housing 951, it is only necessary to control the positional accuracies of the portions that come in contact at two points. Therefore, it becomes easy to perform the molding die management and maintenance of the housing.

In the twelfth embodiment, the recess 901c, as one example of the first turn guide mechanism, has been formed on the thin metal plate 901. However, it is acceptable to form a recess, as one example of the first turn guide mechanism, at the resin part formed integrally with the thin metal plate 901. The recess of the resin part, which can be formed by a resin molding die, can therefore be formed with accuracy higher than that of the recess of the thin metal plate. Therefore, forming the recess at the resin part makes it possible to improve the rotational accuracy of the thin metal plate 901, and the degree of freedom of the shape of the recess.

### Thirteenth Embodiment

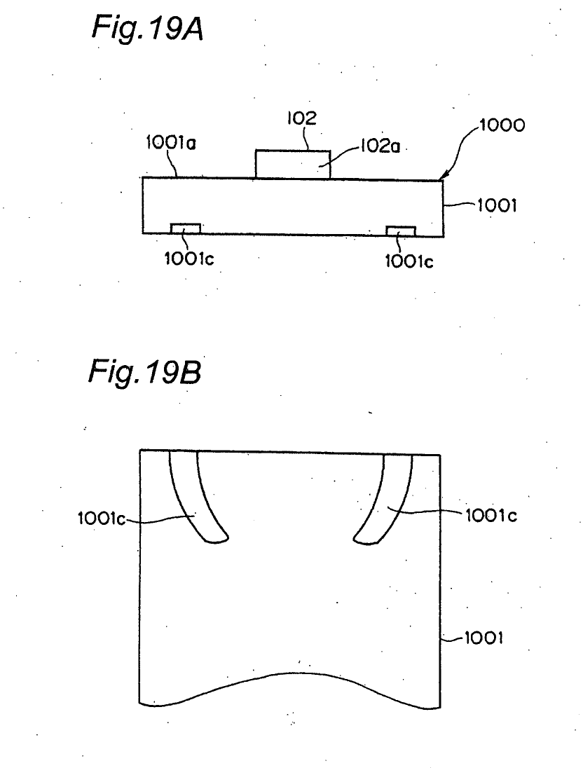

FIG. 19A shows a schematic view of a semiconductor laser device 1000 provided for an optical pickup device according to the thirteenth embodiment of the present invention viewed from the front. FIG. 19B shows a schematic view of the semiconductor laser device 1000 viewed from below.

As shown in FIG. 19A, the semiconductor laser device 1000 has a roughly quadrangular plate shaped thin metal plate 1001, as one example of the metal plate, which has a mounting surface 1001a. The semiconductor laser device 1000 also has an LD chip 102 as one example of the semiconductor laser element that has a front end surface 102a from which laser light is emitted.

The LD chip 102 is fixed to the front end portion of the mounting surface 101a of the thin metal plate 1001 with use of a material of, for example, an indium or silver paste having a good thermal conductivity.

As shown in FIGS. 19A and 19B, two roughly circular arc shaped grooves 1001c, as one example of the first turn guide mechanism, are formed on the back surface (surface on the side opposite to the LD chip 102) of the thin metal plate 1001. The grooves 1001c roughly overlap the circular arc of a circle centered at the light-emitting point of the LD chip 102 in plan view. Moreover, the grooves 1001c have open portions located on the side of the front end surface 102a of the LD chip 102. That is, the front end portions of the grooves 1001c are open. The grooves 1001c are obtained by directly processing the thin metal plate 1001.

Although not shown, the optical pickup device has a housing that includes a mounting surface to which the semiconductor laser device 1000 is attached. Two roughly columnar projections, as one example of the second turn guide mechanism, are formed on the mounting surface of the housing. The two projections are arranged so as to be located roughly on the circumference of a circle centered at the light-emitting point of the LD chip 102 in plan view. Moreover, the projections can be fit in the grooves 1001c of the thin metal plate 1001. The height of the projections is approximately equal to the depth of the grooves 1001c.

According to the optical pickup device of this construction, when the semiconductor laser device 1000 is attached to the mounting surface 1051a of the housing 1051, the projections on the mounting surface of the housing are fit in the grooves 1001c. Thereafter, the thin metal plate 1001 is turned along a plane parallel to the mounting surface 1001a with respect to the housing 1051. Then, the thin metal plate 1001 is turned about the light-emitting point of the LD chip 102 along a plane parallel to the mounting surface 1001a with respect to the housing 1051. Therefore, the inclination adjustment of the LD chip 102 in the direction of q∥ is performed without causing any positional deviation of the light-emitting point of the LD chip 102. Thus, a bad influence can be prevented from being exerted on the recording and reproduction characteristics of the information of the optical disk.

Moreover, using the grooves 1001c, as the first turn guide mechanism, makes it possible to limit the angle of rotation of the thin metal plate 1001 within a definite range. The adjustment range is normally about ±2° to ±3° required for the semiconductor laser device. Therefore, it is only necessary for the grooves 1001c to cover the above-stated angle as a movable range of the thin metal plate 1001. That is, it is only necessary for the grooves 1001c to be able to turn the thin metal plate 1001 by at least −2 to +2°.

When the rotational adjustment range of the thin metal plate is excessively wide in the practical manufacturing processes of an optical pickup device, there is a disadvantage that considerable time is necessary for the fine tuning of the adjustment. This is because the initial position of the rotational adjustment is free. In the thirteenth embodiment, however, the optical pickup device does not need considerable time for the fine tuning of the adjustment.

Although the recesses 1001c, as one example of the first turn guide mechanism, have been formed at the thin metal plate 1001 in the thirteenth embodiment, it is acceptable to form recesses at the resin part formed integrally with the thin metal plate 1001. The recesses of the resin part, which can be formed by a resin molding die, can therefore be formed with accuracy higher than that of the recesses of a thin metal plate. Therefore, the recesses at the resin part make it possible to improve the rotational accuracy of the thin metal plate 1001, and the degree of freedom of the shape of the recesses.

### Fourteenth Embodiment

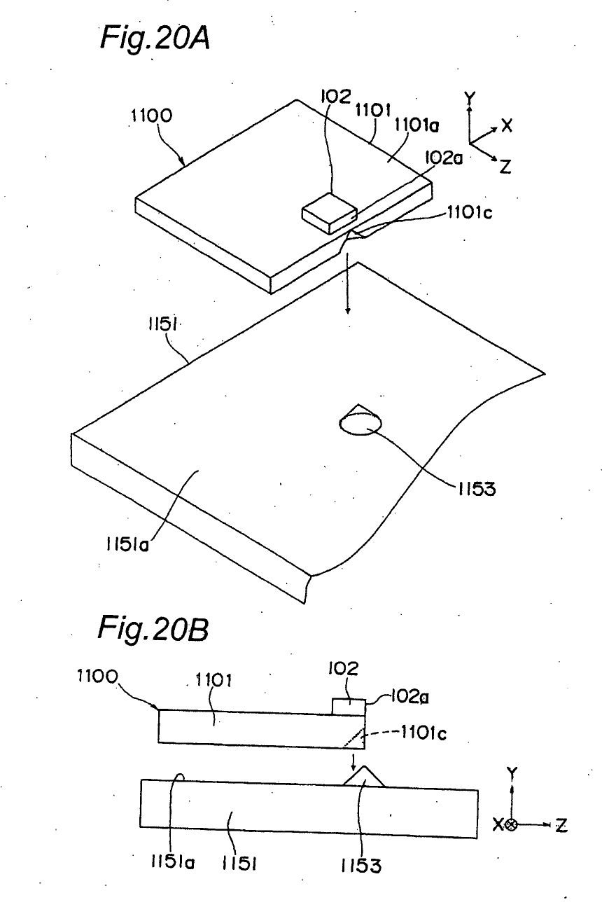

FIG. 20A shows a schematic perspective view of the substantial part of an optical pickup device according to the fourteenth embodiment of the present invention. FIG. 20B shows a schematic view for explaining the inclination adjustment of a semiconductor laser device 1100 provided for the optical pickup device.

As shown in FIG. 20A, the optical pickup device has the semiconductor laser device 1100 and a housing 1151 that has a mounting surface 1151a to which the semiconductor laser device 1100 is attached.

The semiconductor laser device 1100 has a roughly quadrangular plate shaped thin metal plate 1101 and an LD chip 102. The thin plate 1101 serves as one example of the metal plate, and has a mounting surface 1101a. The LD chip 102 serves as one example of the semiconductor laser element, and has a front end surface 102a from which laser light is emitted.

The LD chip 102 is fixed to the front end portion of the mounting surface 1101a of the thin metal plate 1101 with use of a material of, for example, an indium or silver paste having a good thermal conductivity. With this arrangement, the light-emitting point of the LD chip 102 is located in the neighborhood of the front end surface of the thin metal plate 1101. Moreover, the layer thickness direction of the layer that constitutes the LD chip 102 is parallel to the Y-axis direction. That is, the crystal growth direction of the LD chip 102 is parallel to the Y-axis direction.

A roughly semi-conical recess 1101c, as one example of the first turn guide mechanism, is formed on the back surface (surface on the side opposite to the LD chip 102) of the thin metal plate 1101. The end of the recess 1101con the side of the 102 LD chip roughly overlaps the neighborhood of the light-emitting point of the LD chip 102. Moreover, the recess 1101c has an open portion on the side of the front end surface 102a of the LD chip 102. That is, the front end portion of the recess 1101c is open. The recess 1101c is obtained by directly processing the thin metal plate 1101.

A roughly conical projection 1153, as one example of the second turn guide mechanism, is formed on the mounting surface 1151a of the housing 1151. The end of the projection 1153 roughly overlaps the neighborhood of the light-emitting point of the LD chip 102. Moreover, the projection 1153 can be fit in the recess 1101c of the thin metal plate 1101. The height of the projection 1153c is approximately equal to the depth of the recess 1101c.

According to the optical pickup device of this construction, when the semiconductor laser device 1100 is attached to the mounting surface 1151a of the housing 1151, the projection 1153 is fit in the recess 1101c as shown in FIG. 20B. Thereafter, the thin metal plate 1101 is turned along a plane parallel to the mounting surface 1101a with respect to the housing 1151. Then, the thin metal plate 1101 is turned about the light-emitting point of the LD chip 102 along a plane parallel to the mounting surface 1101a with respect to the housing 1151. Therefore, the inclination adjustment of the LD chip 102 in the direction of q∥ is performed without causing any positional deviation of the light-emitting point of the LD chip 102. Thus, a bad influence can be prevented from being exerted on the recording and reproduction characteristics of the information of the optical disk.

Moreover, the recess 1101c has an open portion on the side of the front end surface 102a of the LD chip 102. Therefore, it is easy to form the recess 1101c at the front end portion of the back surface of the thin metal plate 1101, and to produce the recess 1101c with high accuracy.

It is proper to perform the inclination adjustment while measuring the light intensity distribution of the laser light from the front end surface 102a by a CCD camera or the like.

Moreover, after the inclination adjustment of the LD chip 102 in the direction of q∥ is performed, it is proper to fix the semiconductor laser device 1100 to the mounting surface 1151a of the housing 1151 with use of an adhesive of, for example, a photo-curable resin.

In the twelfth embodiment, the roughly disk-shaped projection 1153 has been formed on the mounting surface 1151a of the housing 1151. However, it is acceptable to form, for example, a roughly quadrangular plate shaped or roughly pentagonal plate shaped projection on the mounting surface 1151a of the housing 1151. That is, the shape of the projection formed on the mounting surface 1151a of the housing 1151 only needs to be a shape such that the projection can come in contact with the curved surface of the recess 1101c at two points.

When the projection, which can come in contact with the curved surface of the recess 1101c at two points, is formed on the mounting surface 1151a of the housing 1151, it is required to control only the positional accuracy of the portions brought in contact at two points. Therefore, it becomes easy to perform the molding die management and the maintenance of the housing.

The advantage of the optical pickup device of the fourteenth embodiment resides in that the light-emitting point of the LD chip 102 can be set with high accuracy at the center of the rotational adjustment. The reason is as follows.

A roughly conical recess is preliminarily formed on the back surface of a thin metal plate. An LD chip is next mounted on the thin metal plate. At the time of mounting the LD chip, normally, the LD chip emits light by electrification of the LD chip, then, the image of the light-emitting point is recognized, and thereafter, the LD chip is fixed in the desired position. In this embodiment, however, the apex of the conical recess is utilized as an objective mounting position of the light-emitting point of the LD chip. That is, the roughly conical recess has not only a function as one example of the first turn guide mechanism but also a function as the objective mounting position of the LD chip.

In the fourteenth embodiment, the recess 1101c, as one example of the first turn guide mechanism, has been formed on the thin metal plate 1101. However, it is acceptable to form a recess at the resin part formed integrally with the thin metal plate 1101. The recess of the resin part, which can be formed by a resin molding die, can therefore be formed more accurately than the recess of the thin metal plate. Therefore, forming the recess at the resin part makes it possible to improve the rotational accuracy of the thin metal plate 1101, and the degree of freedom of the shape of the recess.

### Fifteenth Embodiment

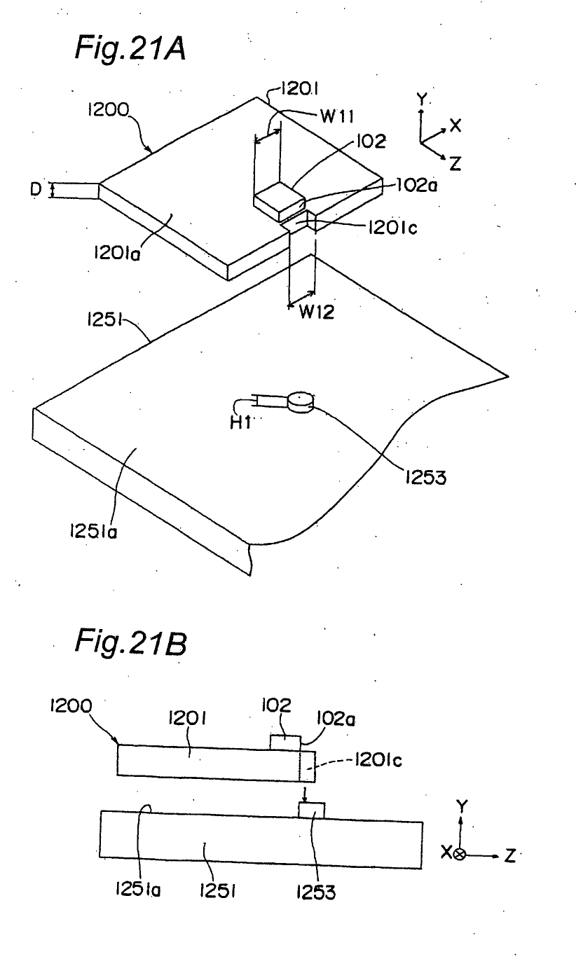

FIG. 21A shows a schematic perspective view of the substantial part of an optical pickup device according to the fifteenth embodiment of the present invention. FIG. 21B shows a schematic view for explaining the inclination adjustment of a semiconductor laser device 1200 provided for the optical pickup device.

As shown in FIG. 21A, the optical pickup device has the semiconductor laser device 1200 and a housing 1251 that has a mounting surface 1251a to which the semiconductor laser device 1200 is attached.

The semiconductor laser device 1200 has a roughly quadrangular plate shaped thin metal plate 1201 and an LD chip 102. The thin metal plate 1201 serves as one example of the metal plate and has a mounting surface 1201a. The LD chip 102 serves as one example of the semiconductor laser element and has a front end surface 102a from which laser light is emitted.

The LD chip 102 is fixed to the front end portion of the mounting surface 1201a of the thin metal plate 1201 with use of a material of, for example, an indium or silver paste having a good thermal conductivity. With this arrangement, the light-emitting point of the LD chip 102 is located in the neighborhood of the front end surface of the thin metal plate 1201. Moreover, the layer thickness direction of the layer that constitutes the LD chip 102 is parallel to the Y-axis direction. That is, the crystal growth direction of the LD chip 102 is parallel to the Y-axis direction.

A cut 1201c, as one example of the first turn guide mechanism, is formed at the edge portion (front end portion of the thin metal plate 1201) on the side of the front end surface 102a of the thin metal plate 1201. The cut 1201c is located in the neighborhood of the front end surface 102a of the LD chip 102. Moreover, a width W12 in the X-axis direction of the cut 1201c is approximately equal to a width W11 in the X-axis direction of the LD chip 102. The cut 1201c is obtained by directly processing the thin metal plate 1201.

A roughly columnar projection 1253, as one example of the second turn guide mechanism, is formed on the mounting surface 1251a of the housing 1251. A height H1 of the projection 1253 is smaller than the thickness D of the thin metal plate 1201. The projection 1253 is fit in the cut 1201c of the thin metal plate 1201.

According to the optical pickup device of this construction, when the semiconductor laser device 1200 is attached to the mounting surface 1251a of the housing 1251, the projection 1253 is fit in the cut 1201c as shown in FIG. 21B. Thereafter, the thin metal plate 1201 is turned along a plane parallel to the mounting surface 1201a with respect to the housing 1251. Then, the thin metal plate 1201 is turned about the light-emitting point of the LD chip 102 along a plane parallel to the mounting surface 1201a with respect to the housing 1251. Therefore, the inclination adjustment of the LD chip 102 in the direction of q∥ is performed without causing any positional deviation of the light-emitting point of the LD chip 102. Thus, a bad influence can be prevented from being exerted on the recording and reproduction characteristics of the information of the optical disk.

It is proper to perform the inclination adjustment while measuring the light intensity distribution of the laser light from the front end surface 102a by a CCD camera or the like.

After the inclination adjustment of the LD chip 102 in the direction of q∥ is performed, it is proper to fix the semiconductor laser device 1200 to the mounting surface 1251a of the housing 1251 with use of an adhesive of, for example, a photo-curable resin.

The cut 1201c is formed in the neighborhood of the front end surface 102a of the LD chip 102, and therefore, the laser light emitted from the front end surface 102a of the LD chip 102 can be prevented from being disordered as a consequence of collision with the thin metal plate 1201. That is, ripple light can be prevented from being generated.

The height H1 of the projection 1253 is smaller than the thickness D of the thin metal plate 1201, and therefore, the effect of suppressing the generation of ripple light can be improved.

The width X2 in the X-axis direction of the cut 1201c approximately equals to the width in the X-axis direction of the LD chip 102. Thereby, it is possible to minimize the size of the cut 1201c, increase the thermal capacity of the thin metal plate 1201 and secure the heat radiation property of the LD chip 102.

In other words, the optical pickup device of the present embodiment is able to prevent ripples due to the semiconductor laser device 1200 itself, to provide a rotational adjustment mechanism, and to prevent ripples from the housing projection that becomes a rotational adjustment mechanism.

The surface of the projection 1253 more effectively prevents the ripple light at the projection 1253, and therefore, the surface may be a light scattering surface.

In order to more effectively avoid the ripple at the projection 1253, the surface of the projection 1253 may be in black.

### Sixteenth Embodiment

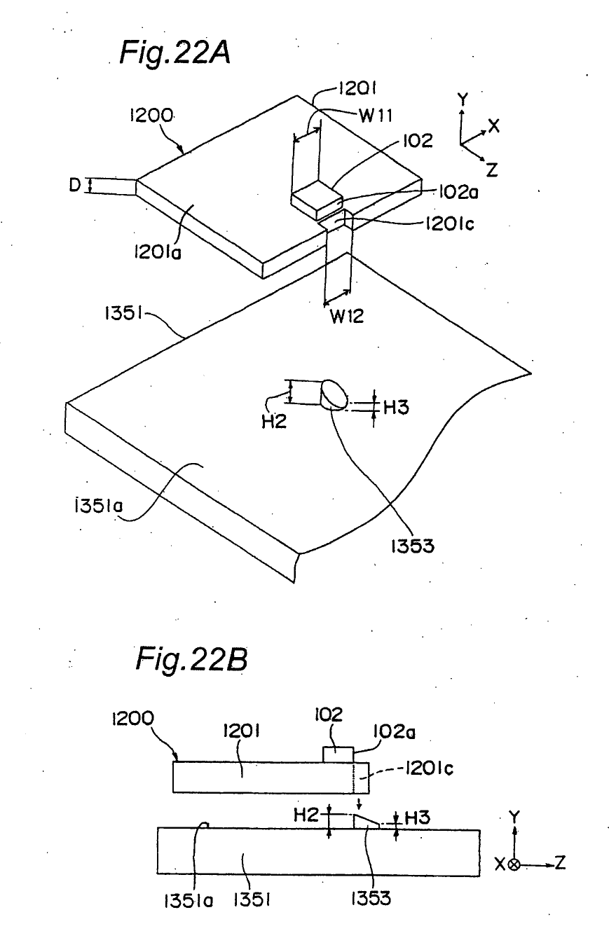

FIG. 22A shows a schematic perspective view of the substantial part of an optical pickup device according to the sixteenth embodiment of the present invention. FIG. 22B shows a schematic view for explaining the inclination adjustment of the semiconductor laser device 1200 provided for the optical pickup device.

As shown in FIG. 22A, the optical pickup device has the semiconductor laser device 1200 and a housing 1251 that has a mounting surface 1251a to which the semiconductor laser device 1200 is attached.

The semiconductor laser device 1200 has a roughly quadrangular plate shaped thin metal plate 1201 and an LD chip 102. The thin metal plate 1201 serves as one example of the metal plate and has a mounting surface 1201a. The LD chip 102 serves as one example of the semiconductor laser element and has a front end surface 102a from which laser light is emitted.

The LD chip 102 is fixed to the front end portion of the mounting surface 1201a of the thin metal plate 1201 with use of a material of, for example, an indium or silver paste having a good thermal conductivity. With this arrangement, the light-emitting point of the LD chip 102 is located in the neighborhood of the front end surface of the thin metal plate 1201. Moreover, the layer thickness direction of the layer that constitutes the LD chip 102 is parallel to the Y-axis direction. That is, the crystal growth direction of the LD chip 102 is parallel to the Y-axis direction.

A cut 1201c, as one example of the first turn guide mechanism, is formed at the edge portion (front end portion of the thin metal plate 1201) located on the side of the front end surface 102a of the thin metal plate 1201. The cut 1201c is located in the neighborhood of the front end surface 102a of the LD chip 102. Moreover, a width W12 in the X-axis direction of the cut 1201c is approximately equal to a width W11 in the X-axis direction of the LD chip 102. The cut 1201c is obtained by directly processing the thin metal plate 1201.

A roughly columnar projection 1353, as one example of the second turn guide mechanism, is formed on a mounting surface 1351a of the housing 1351. A height H2 of the rear end of the projection 1353 located on the side of the LD chip 102 is smaller than the thickness D of the thin metal plate 1201. Specifically, the height of the projection 1353 is gradually lowered away from the light-emitting point of the LD chip 102. A height H3 of the front end of the projection 1353 located on the side opposite to the LD chip 102 is smaller than a height H2 of an end located on the side of the LD chip 102 of the projection 1353. The projection 1353 is fit in the cut 1201c of the thin metal plate 1201.

According to the optical pickup device of this construction, when the semiconductor laser device 1200 is attached to the mounting surface 1351a of the housing 1351, the projection 1353 is fit in the cut 1201c as shown in FIG. 22B. Thereafter, the thin metal plate 1201 is turned along a plane parallel to the mounting surface 1201a with respect to the housing 1351. Then, the thin metal plate 1201 is turned about the light-emitting point of the LD chip 102 along a plane parallel to the mounting surface 1201a with respect to the housing 1351. Therefore, the inclination adjustment of the LD chip 102 in the direction of q∥ is performed without causing any positional deviation of the light-emitting point of the LD chip 102. Thus, a bad influence can be prevented from being exerted on the recording and reproduction characteristics of the information of the optical disk.

Since the height H3 of the front end of the projection 1353 is made lower than the height H2 of the rear end of the projection 1353, the generation of ripple light can more effectively be prevented.

So long as the projection 1353 is located in a position where the laser intensity is sufficiently low, the ripple light practically causes no problem even if the projection 1353 reflects the laser light.

The laser intensity distribution is a Gaussian distribution, and therefore, the intensity is reduced away from the center portion of the laser light. Assuming that the center intensity of the laser light is 1 (one), a luminous flux up to an intensity of about 1/e² is utilized in the ordinary optical pickup device. Therefore, laser light reflected on the projection 1353 practically causes no problem when the laser light has a laser intensity of not greater than 1/e².

Therefore, the height H2 of the end of the projection 1353 located on the side of the LD chip 102 is set such that the intensity of the laser light is not greater than 1/e². Thereby, it is possible to provide a rotational adjustment mechanism that generates no ripple light.

### Seventeenth Embodiment

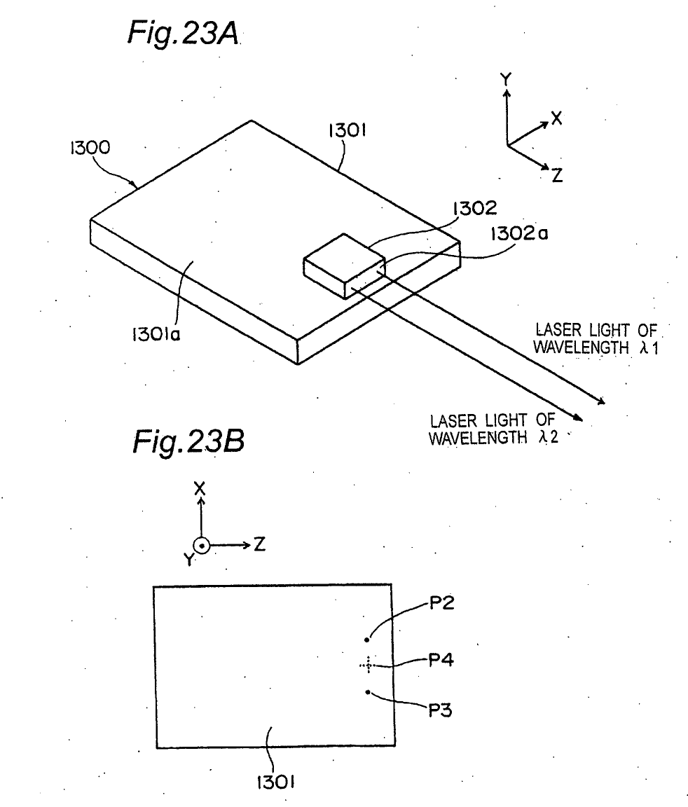

FIG. 23A shows a schematic perspective view of the substantial part of a semiconductor laser device 1300 provided for the optical pickup device of the seventeenth embodiment of the present invention. FIG. 23B shows a schematic view of the semiconductor laser device 1300 viewed from above. FIG. 23B does not show a dual wavelength LD chip 1302.

As shown in FIG. 23A, the semiconductor laser device 1300 has a roughly quadrangular plate shaped thin metal plate 1301 and a dual wavelength LD chip 1302. The thin metal plate 1301 serves as one example of the metal plate and has a mounting surface 1301a. The dual wavelength LD chip 1302 serves as one example of the semiconductor laser element and has a front end surface 1302a from which laser light beams of different wavelengths λ1 and λ2 are emitted.

The dual wavelength LD chip 1302 is a so-called monolithic type dual wavelength laser in which two laser elements are formed in one crystal. In the dual wavelength LD chip 1302, two laser elements in an identical crystal are formed with accuracy on the atomic level by using a MOCVD (Metal-organic Chemical Vapor Deposition) apparatus or the like. Therefore, the laser light of the wavelength λ1 and the laser light of the wavelength λ2 are accurately matched with each other in the direction of θ∥ on the LD chip. As shown in FIG. 23B, the laser light of the wavelength λ1 is emitted from a light-emitting point P2. On the other hand, the laser light of the wavelength λ2 is emitted from a light-emitting point P3.

When the dual wavelength LD chip 1302 is mounted on the thin metal plate 1301, an inclination error of 2 to 3° occurs in the direction of θ∥ with regard to the entire dual wavelength LD chip 1302. That is, when the dual wavelength LD chip 1302 is mounted on the thin metal plate 1301, the directions, in which the laser light beams of the wavelengths λ1 and λ2 are emitted, disadvantageously incline in the same direction with respect to a prescribed direction because of variation in the mounting process. For this reason, the dual wavelength LD chip 1302 is fixed to the mounting surface 1301a with the inclination error.

A first turn guide mechanism like, for example, the recess 801c of the eleventh embodiment is formed on the thin metal plate 1301. The first turn guide mechanism enables the thin metal plate 1301 to turn along a plane parallel to the mounting surface 1301a with respect to the housing of the optical pickup device. A rotational center P4 of the thin metal plate 1301 roughly overlaps an approximate midpoint between the light-emitting point P2 and the light-emitting point P3. More specifically, the rotational center P4 and the light-emitting points P2 and P3 roughly overlap an identical straight line, and a distance between the rotational center P4 and the light-emitting point P2 is approximately equal to a distance between the rotational center P4 and the light-emitting point P3.

As described above, the rotational center P4 is not located at the same position as those of the light-emitting points P2 and P3. Therefore, as a matter of course, the thin metal plate 1301 does not turn around the light-emitting points P2 and P3. Strictly, positions of the light-emitting points P2 and P3 change in accordance with the turn of the thin metal plate 1301. However, the distance between the light-emitting points P2 and P3 normally is very small from about several tens of micrometers to one hundred micrometers. Thus, the positional changes of the light-emitting points P2 and P3 in accordance with the turn of the thin metal plate 1301 are very small, and cause no problem so long as the rotational center P4 is located roughly in the middle between the light-emitting points P2 and P3.

Given that the rotational center P4 is not located in the middle between the light-emitting points P2 and P3 but in a location other than the position., then, one of the light-emitting points P2 and P3, which is located farther away from the rotational center P4, has a greater change in position by the turn of the thin metal plate 1301.

In the present embodiment, the dual wavelength laser has been described. However, this embodiment may apply to a multiple wavelength laser of three or more wavelengths under the condition that the rotational center of the thin metal plate roughly overlaps the midpoint of a plurality of light-emitting points as in the case of the dual wavelength laser.

Although the dual wavelength LD chip 1302 has been the monolithic type dual wavelength laser in the present embodiment, a hybrid type dual wavelength laser may be employed.

In the case that the dual wavelength LD chip 1302 is the hybrid type dual wavelength laser, the dual wavelength LD chip 1302 is obtained by employing an LD chip that emits laser light of the wavelength λ1 and an LD chip that emits laser light of the wavelength λ2 and is manufactured separately from the LD chip.

It should be noted that even when the dual wavelength LD chip 1302 is the hybrid type dual wavelength laser, it is still the requirement for reducing the positional changes of the light-emitting points P2 and P3 in accordance with the turn of the thin metal plate 1301 that the rotational center P4 of the thin metal plate 1301 should be superimposed on the approximate midpoint between the light-emitting points P2 and P3.

The hybrid type dual wavelength laser differs from the monolithic type dual wavelength laser in large distance between the light-emitting points, specifically, several hundreds of micrometers. Therefore, when the hybrid type dual wavelength laser is used for the dual wavelength LD chip 1302, the positional changes of the light-emitting points P2 and P3 are large which are caused in accordance with the turn of the thin metal plate 1301. However, the hybrid type dual wavelength laser can be used for the dual wavelength LD chip 1302 without any problem when the turn of the thin metal plate 1301 is small or when the changes of the light-emitting points P2 and P3 cause no harmful effect on an optical pickup device (e.g., an optical pickup device for CD and DVD reproduction use)

### Eighteenth Embodiment

In the present embodiment, there is explained a semiconductor laser device in which a dual wavelength LD chip is mounted on a thin metal plate. The dual wavelength LD chip is constructed of a high-power laser light source for recording and reproduction of the wavelength λ1 and a low-power laser light source for reproduction of the wavelength λ2.

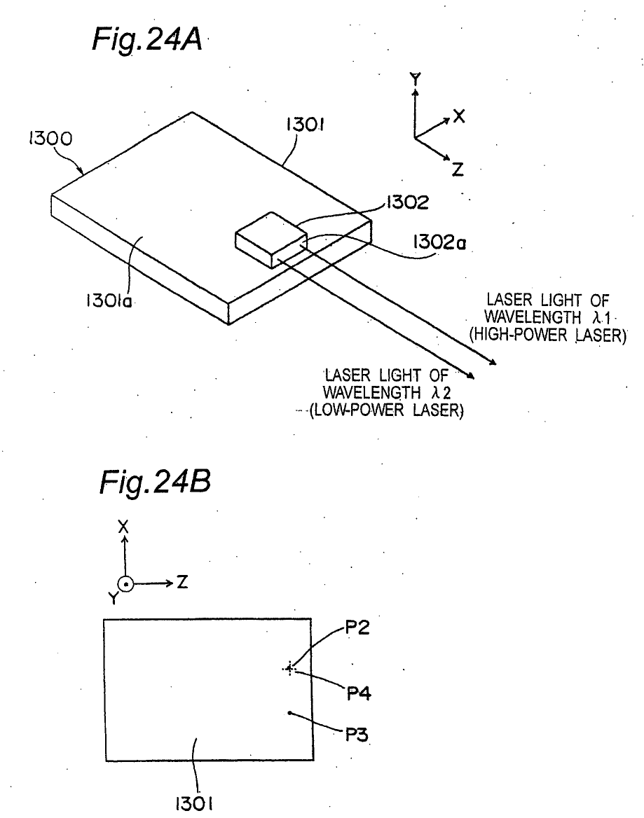

FIG. 24A shows a schematic perspective view of the substantial part of a semiconductor laser device 1300 provided for the optical pickup device according to the eighteenth embodiment of the present invention. FIG. 24B shows a schematic view of the semiconductor laser device 1300 viewed from above. The dual wavelength LD chip 1302 is not shown in FIG. 24B.

As shown in FIG. 24A, the dual wavelength LD chip 1302 has a roughly quadrangular plate shaped thin metal plate 1301 and a dual wavelength LD chip 1302. The thin metal plate 1301 serves as one example of the metal plate and has a mounting surface 1301a. The dual wavelength LD chip 1302 serves as one example of the semiconductor laser element and has a front end surface 1302a from which the laser light beams of two different wavelengths λ1 and λ2 are emitted.

As shown in FIG. 24B, the laser light of the wavelength λ1 is emitted from the light-emitting point P2. On the other hand, the laser light of the wavelength λ2 is emitted from the light-emitting point P3.

The laser light of the wavelength λ1 is used for recording a signal on an optical disk and reproducing the signal recorded on the optical disk. On the other hand, the laser light of the wavelength λ2 is used only for reproducing the signal recorded on an optical disk.

In order to perform high-quality signal recording of a high S/N (signal-to-noise) ratio on the optical disk, it is required that the light spot condensed on the recording surface of the optical disk is of high quality. In the present embodiment, therefore, the rotational center P4 of the thin metal plate 1301 roughly overlaps the light-emitting point P2 of the laser light of the wavelength λ1.

With this arrangement, the inclination adjustment of the LD chip 1302 in the direction of q∥ can be performed by turning the thin metal plate 1301 around the light-emitting point P2 of the laser light of the wavelength λ1, which is important for signal recording on the optical disk, along a plane parallel to the mounting surface 1301a. That is, the inclination adjustment of the LD chip 1302 in the direction of q∥ can be performed without moving the position of the light-emitting point P2.

On the other hand, the light-emitting point P3 of the laser light of the wavelength λ2 is disadvantageously moved by the inclination adjustment because the light-emitting point P3 is apart from the rotational center P4. However, even when the light spot for reproduction has a lower quality than that for recording, no problem occurs in particular.

That is, it is important to form the first turn guide mechanism on the thin metal plate 1301, the first turn guide mechanism making it possible to turn the thin metal plate 1301 along a plane parallel to the mounting surface 1301a around the light-emitting point P2 of the high-power laser where the quality of the light spot is more important.

In the present embodiment, there is explained the case of the laser light beams of two wavelengths. Also in the case of laser beams of three or more different wavelengths, it is only necessary for the rotational center of the thin metal plate to be roughly located at the light-emitting point of the laser light of the highest power.

Although the high-power laser light is used in order to perform high-speed recording, it is required to not only increase the optical power but also improve the quality of the light spot in order to achieve the high-speed recording.

### Nineteenth Embodiment

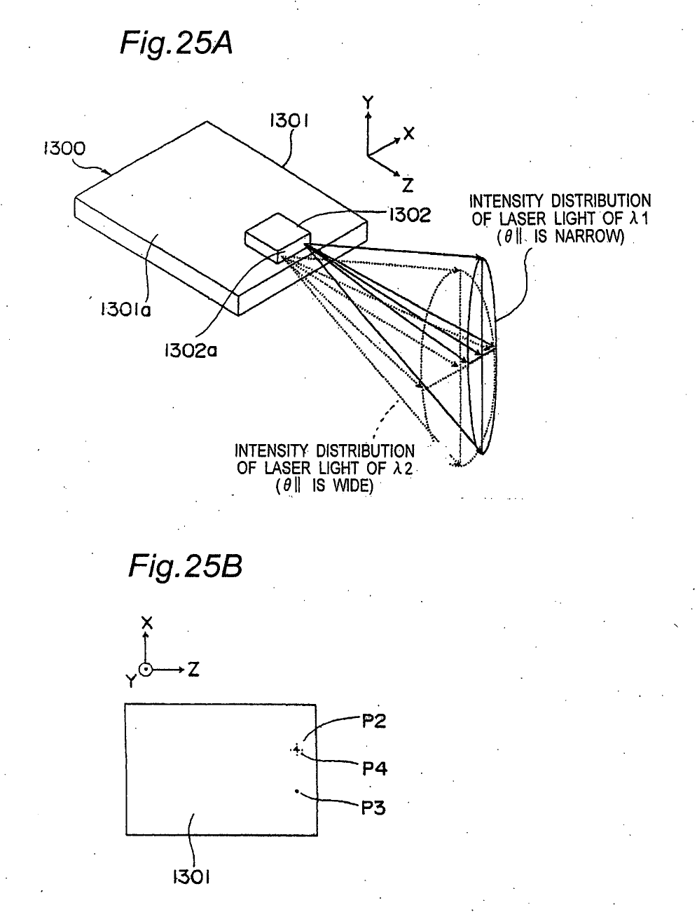

FIG. 25A shows a schematic perspective view of the substantial part of a semiconductor laser device 1300 provided for the optical pickup device according to the nineteenth embodiment of the present invention. FIG. 25B shows a schematic view of the semiconductor laser device 1300 viewed from above. The dual wavelength LD chip 1302 is not shown in FIG. 25B.

As shown in FIG. 25A, the semiconductor laser device 1300 has a roughly quadrangular plate shaped thin metal plate 1301 and a dual wavelength LD chip 1302. The thin metal plate 1301 serves as one example of the metal plate and has a mounting surface 1301a. The dual wavelength LD chip 1302 serves as one example of the semiconductor laser element and has a front end surface 1302a from which the laser light beams of two different wavelengths λ1 and λ2 are emitted.

As shown in FIG. 25B, the laser light of the wavelength λ1 is emitted from the light-emitting point P2. On the other hand, the laser light of the wavelength λ2 is emitted from the light-emitting point P3.

As shown in FIG. 25A, θ∥ of the laser light of the wavelength λ1 is narrower than θ∥ of the laser light of the wavelength λ2.

As described above in connection with the background art, the influence of the inclination Δθ∥ is small when θ∥ is wide. However, when θ∥ is narrow, the influence of Δθ∥ is increased to deteriorate the quality of the light spot condensed on the recording surface of the optical disk, influencing the signal recording and reproduction characteristics.

Therefore, in the present embodiment, the quality of the light spot is prevented from deteriorating by superposing the rotational center P4 of the thin metal plate 1301 roughly on the light-emitting point P2.

That is, in the present embodiment, the first turn guide mechanism is formed on the thin metal plate 1301 such that the first turn guide mechanism enables the thin metal plate 1301 to turn along a plane parallel to the mounting surface 1301a with respect to the housing of the optical pickup device around the light-emitting point P2 of the laser light. The light-emitting point P2 of θ∥ is narrow and is more sensitive to the quality of the spot.

Although the laser light beams of two wavelengths exist in the present embodiment according to the description, the rotational center of the thin metal plate only needs to be located roughly at the light-emitting point of the laser light of the highest power also in a case where laser beams of three or more different wavelengths exist.

### Twentieth Embodiment

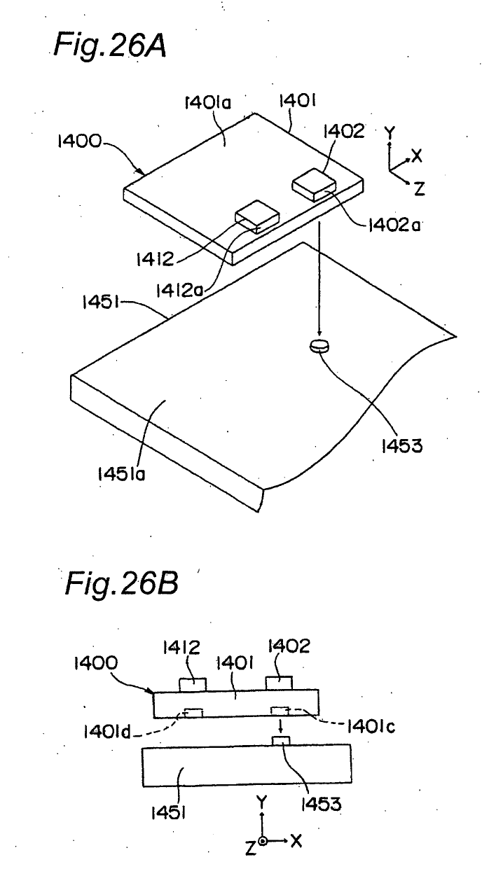

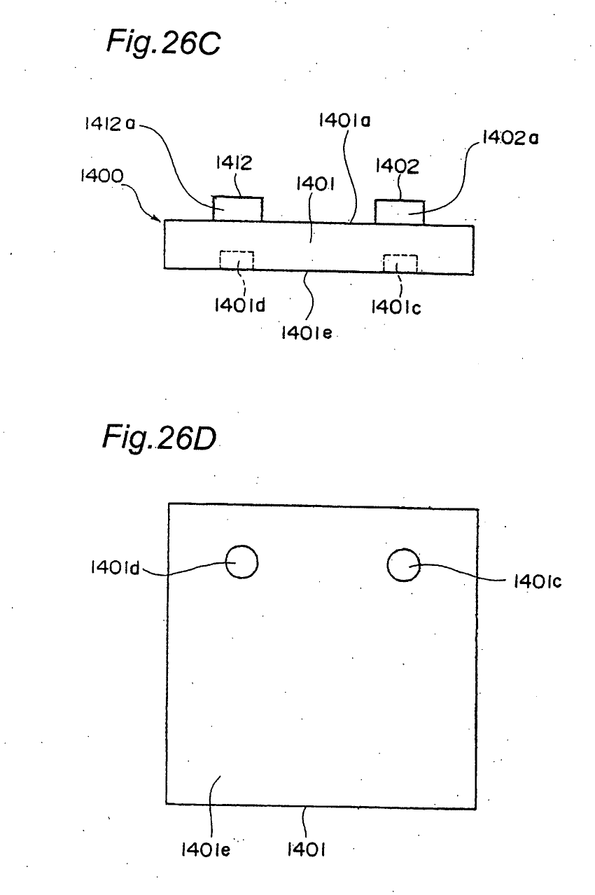

FIG. 26A shows a schematic view of the substantial part of an optical pickup device according to the twentieth embodiment of the present invention viewed obliquely from above. FIG. 26B shows a schematic view for explaining the inclination adjustment of a semiconductor laser device 1400 provided for the optical pickup device.

As shown in FIG. 26A, the optical pickup device has the semiconductor laser device 1400 and a housing 1451 that has a mounting surface 1451a to which the semiconductor laser device 1400 is attached.

FIG. 26C shows a schematic view of the semiconductor laser device 1400 viewed from the front. FIG. 26D shows a schematic view of the semiconductor laser device 1400 viewed from below.

As shown in FIGS. 26A and 26C, the semiconductor laser device 1400 has a roughly quadrangular plate shaped thin metal plate 1401, an LD chip 1402 and an LD chip 1412. The thin metal plate 1401 serves as one example of the metal plate and has a mounting surface 1401a. The LD chip 1402 serves as one example of the semiconductor laser element and has a front end surface 1402a from which laser light of the wavelength λ1 is emitted. The LD chip 1412 serves as one example of the semiconductor laser element and has a front end surface 1412a from which laser light of the wavelength λ2 different from the wavelength λ1 is emitted.

The LD chips 1402 and 1412 are fixed to the front end portion of the mounting surface 1401a of the thin metal plate 1401 with use of a material of, for example, an indium or silver paste having a good thermal conductivity. With this arrangement, the light-emitting points of the LD chips 1402 and 1412 are located in the neighborhood of the front end surface of the thin metal plate 1401. Moreover, the layer thickness direction of the layer that constitutes the LD chips 1402 and 1412 is parallel to the Y-axis direction. That is, the crystal growth direction of the LD chip 102 is parallel to the Y-axis direction.

As shown in FIGS. 26C and 26D, roughly cylindrical recesses 1401c and 1401d, as one example of the first turn guide mechanism, are formed on the back surface 1401e of the thin metal plate 1401 on the opposite side to the LD chips 1402 and 1412. The recess 1401c and the recess 1401d have a roughly identical shape. Moreover, the recess 1401c is located below the LD chip 1402, while the recess 1401d is located below the LD chip 1412. In other words, the recess 1401c is aligned with the light-emitting point of the LD chip 1402, while the recess 1401d is aligned with the light-emitting point of the LD chip 1412. The recesses 1401c and 1401d are obtained by directly processing the thin metal plate 1401.

As shown in FIGS. 26A and 26B, a roughly columnar projection 1453, as one example of the second turn guide mechanism, is formed on the mounting surface 1451a of the housing 1451. The side surface, i.e., the circumferential surface of the projection 1453 roughly overlaps the circumference of a circle centered at the light-emitting point of the LD chip 102 in plan view. Moreover, the projection 1453 is fit in the recesses 1401c and 1401d of the thin metal plate 1401. Therefore, the diameter of the projection 1453 is set so that the projection 1453 can be fit in the recesses 1401c and 1401d. Moreover, the height of the projection 1453c is approximately equal to the depth of the recesses 1401c and 1401d.

According to the optical pickup device of this construction, for example, when the laser light of the wavelength λ1 is the laser light of 650 nm whose θ∥ is narrow for DVD disk reproduction and the laser light of the wavelength λ2 is the laser light of 780 nm whose θ∥ is wide for CD-R reproduction, the projection 1453 is fit in the recess 1401c as shown in FIG. 26B. Thereafter, the thin metal plate 1401 is turned along a plane parallel to the mounting surface 1401a with respect to the housing 1451. Then, the thin metal plate 1401 is turned about the light-emitting point of the LD chip 1402 along a plane parallel to the mounting surface 1401a with respect to the housing 1451. Therefore, the inclination adjustment of the LD chip 1402 in the direction of q∥ is performed without causing any positional deviation of the light-emitting point of the LD chip 1402. Thus, a bad influence can be prevented from being exerted on the recording and reproduction characteristics of the information of the optical disk.

Moreover, for example, when the power of the laser light of the wavelength λ2 is greater than the power of the laser light of the wavelength λ1, the projection 1453 is fit in the recess 1401d. Thereafter, the thin metal plate 1401 is turned along the plane parallel to the mounting surface 1401a with respect to the housing 1451. Thereby, the inclination adjustment in the direction of θ∥ of the LD chip 1412 is performed without causing any positional deviation of the light-emitting point of the LD chip 1412.

It is proper to perform the inclination adjustment while measuring the light intensity distribution of the laser light from the front end surfaces 1402a and 1412a by using a CCD camera or the like.

Moreover, after the inclination adjustment of the LD chips 1402 and 1412 in the direction of q∥ is performed, it is proper to fix the semiconductor laser device 1400 to the mounting surface 1451a of the housing 1451 with use of an adhesive of, for example, a photo-curable resin.

In the present embodiment, the recesses 1401c and 1401d, as one example of the first turn guide mechanism, have been formed on the thin metal plate 1401. However, it is acceptable to form recesses at the resin part formed integrally with the thin metal plate 1401. The recesses of the resin part, which can be formed by a resin molding die, can therefore be formed more accurately than the recesses of the thin metal plate. Therefore, forming the recesses at the resin part makes it possible to improve the rotational accuracy of the thin metal plate 1401, and the degree of freedom of the shape of the recesses.

In the present embodiment, two LD chips 1402 and 1412 have been mounted on the thin metal plate 1401. However, it is acceptable to mount three or more LD chips on the thin metal plate. When three or more LD chips are mounted on the thin metal plate, it is proper to form recesses corresponding to the number of the LD chips on the thin metal plate.

### Twenty-First Embodiment

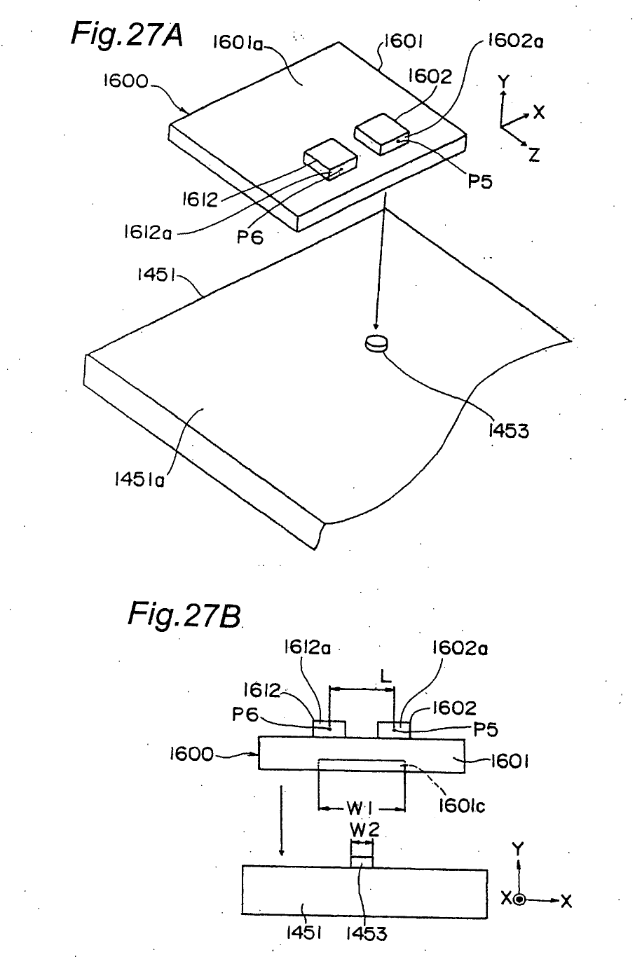

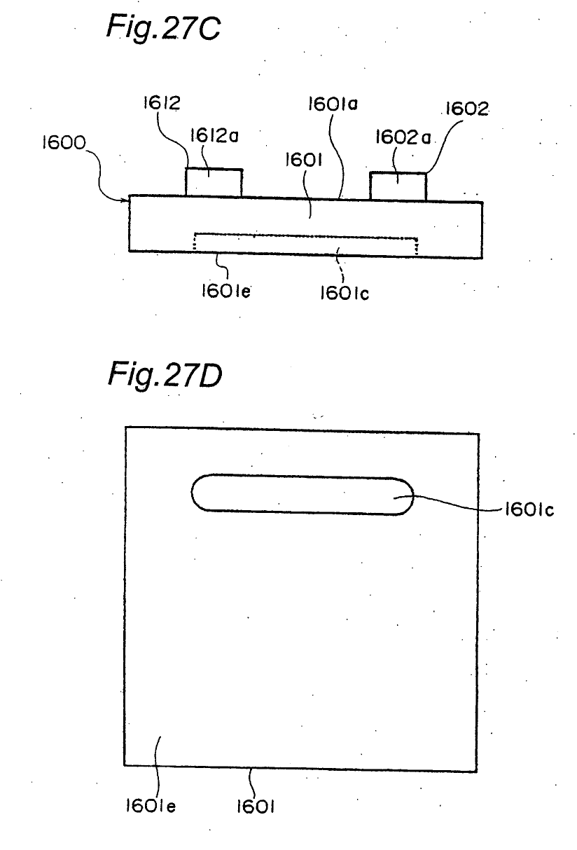

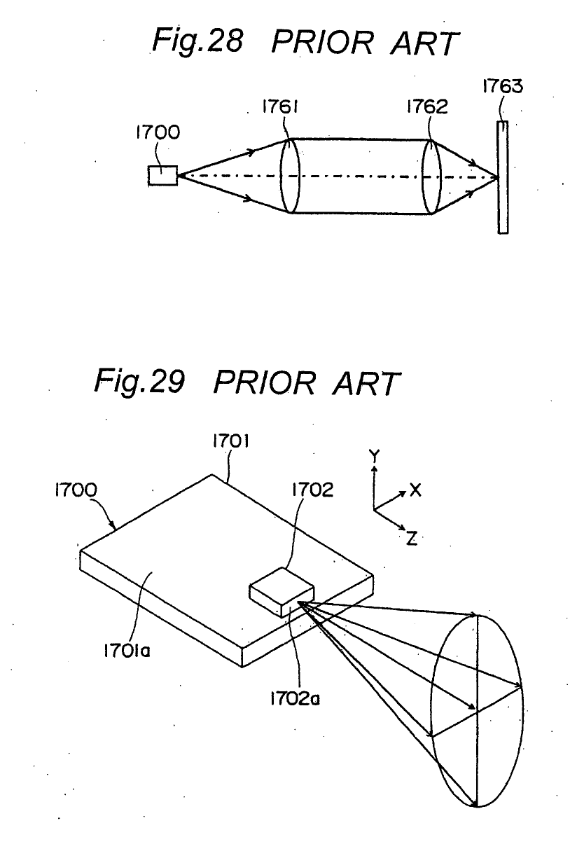

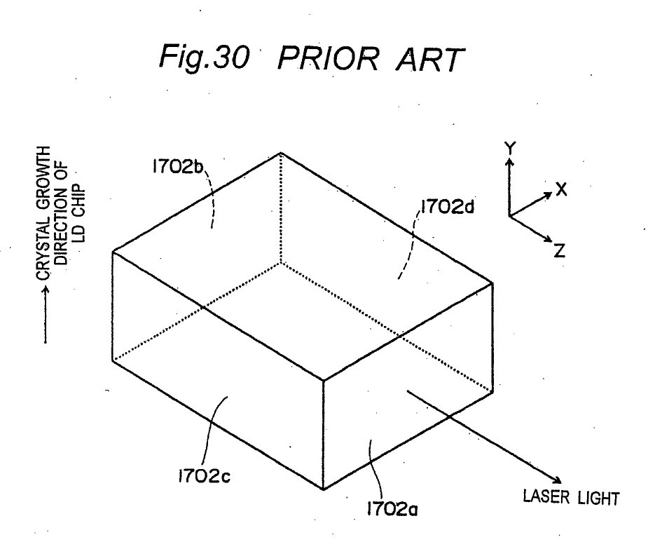

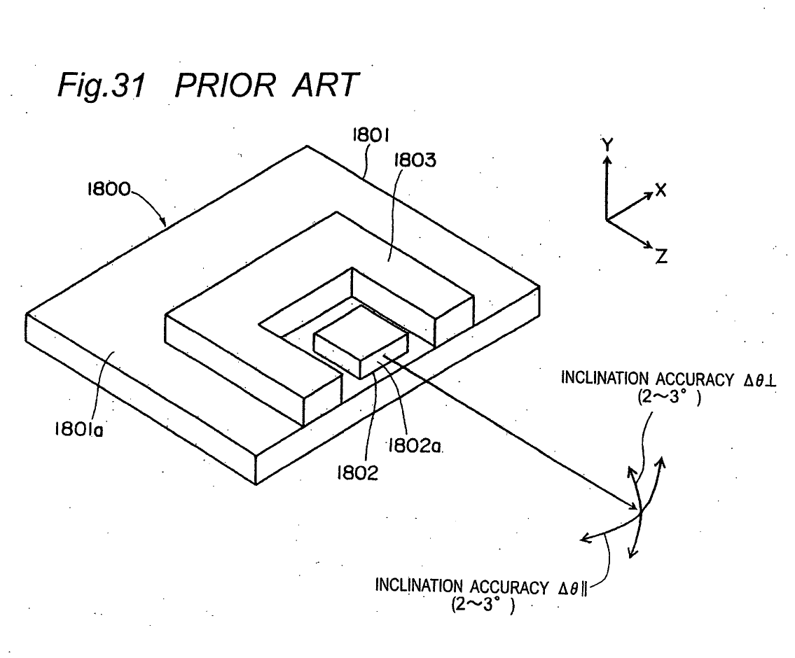

FIG. 27A shows a schematic view of the substantial part of an optical pickup device according to the twenty-first embodiment of the present invention viewed obliquely from above. FIG. 27B shows a schematic view for explaining the inclination adjustment of a semiconductor laser device 1600 provided for the optical pickup device.

As shown in FIG. 27A, the optical pickup device has the semiconductor laser device 1600 and a housing 1651 that has a mounting surface 1651a to which the semiconductor laser device 1600 is attached.

FIG. 27C shows a schematic view of the semiconductor laser device 1600 viewed from the front. FIG. 27D shows a schematic view of the semiconductor laser device 1600 viewed from below.

As shown in FIGS. 27A and 27C, the semiconductor laser device 1600 has a roughly quadrangular plate shaped thin metal plate 1601, an LD chip 1602 and an LD chip 1612. The thin metal plate 1601 serves as one example of the metal plate and has a mounting surface 1601a. The LD chip 1602 serves as one example of the semiconductor laser element and has a front end surface 1602a from which laser light of the wavelength λ1 is emitted. The LD chip 1612 serves as one example of the semiconductor laser element and has a front end surface 1612a from which laser light of the wavelength λ2 different from the wavelength λ1 is emitted.

The LD chips 1602 and 1612 are fixed to front end portions of the mounting surface 1601a of the thin metal plate 1601 with use of a material of, for example, an indium or silver paste having a good thermal conductivity. With this arrangement, light-emitting points P5 and P6 of the LD chips 1602 and 1612 are located in the neighborhood of the front end surface of the thin metal plate 1601. Moreover, the layer thickness direction of the layers that constitute the LD chips 1602 and 1612 is parallel to the Y-axis direction. That is, the crystal growth direction of the LD chip 102 is parallel to the Y-axis direction.

As shown in FIGS. 27C and 27D, a roughly oval (elliptic) recess 1601c, as one example of the first turn guide mechanism, is formed on the back surface 1601e of the thin metal plate 1601 on the opposite side to the LD chips 1602 and 1612. The recess 1601c is located below the LD chips 1602 and 1612. In other words, one end of the recess 1601c is located under the light-emitting point P5 of the LD chip 1602, while the other end portion of the recess 1601c is located under the light-emitting point P6 of the LD chip 1612. The recess 1601c is obtained by directly processing the thin metal plate 1601.

As shown in FIGS. 27A and 27B, a roughly columnar projection 1453, as one example of the second turn guide mechanism, is formed on the mounting surface 1651a of the housing 1651. The projection 1453 can be set in the recess 1601c of the thin metal plate 1601. The height of the projection 1453c is approximately equal to the depth of the recess 1601c.

As shown in FIG. 27B, the width W1 in the lengthwise direction (X-axis direction) of the recess 1601c is greater than a distance L between the light-emitting point P5 and the light-emitting point P6. Moreover, the projection 1453 has a width W2 (diameter). The distance L, the width W1 and the width W2 have the following relations.
L<W1
W2≈W1−L

The above-stated relations mean that the light-emitting point P5 of the laser light of the wavelength λ1 or the light-emitting point P6 of the laser light of the wavelength λ2 (i.e. the movable range thereof above the projection 1453) is located between the projection 1453 and the recess 1601c in the horizontal direction. That is, the projection 1453 limits the movable range of the semiconductor laser device 1600 within the range of the distance between the light-emitting points (specifically, the distance L between the light-emitting point P5 and the light-emitting point P6).

Therefore, when the thin metal plate 1601 is turned while making the projection 1453 hold against the end in the lengthwise direction of the recess 1453 (i.e. against the circumference of the recess 1453), it becomes possible to not only perform the inclination adjustment around the light-emitting point P5 or the light-emitting point P6, but also perform rotational adjustment in an arbitrary position between the two light-emitting points P5 and P6.

According to the optical pickup device of this construction, the inclination adjustment of the LD chip 1602 in the direction of q∥ can optimally be performed even if, for example, the laser light of the wavelength λ1 is the laser light for DVD recording and the laser light of the wavelength λ2 is the laser light for CD-R/RW recording.

In the case, the inclination adjustment of the LD chip 1602 in the direction of q∥ is performed as follows.

Both of the laser light of the wavelengths λ1 and λ2 have high powers, and therefore, it is not unconditionally determined which of the light-emitting points P5 and P6 should optimally serve as the rotational center of the thin metal plate 1601. Accordingly, first, the thin metal plate 1601 is turned around an approximate midpoint between the light-emitting point P5 and the light-emitting point P6 to perform the inclination adjustment of the LD chip 1602 in the direction of q∥.

Next, the performance of the optical pickup device is confirmed. As the result, when it is determined that the DVD recording performance checked by the laser light of the wavelength λ1 is insufficient and that the CD-R/RW performance checked by the laser light of the wavelength λ2 has a tolerance, the inclination adjustment of the LD chip 1602 in the direction of q∥ is performed again by bringing the rotational center of the thin metal plate 1601 nearer to the side of the light-emitting point P5 of the laser light of the wavelength λ1.

It is needless to say that the optical pickup device of the present embodiment produces the same effect as that of the optical pickup device of the twentieth embodiment.

In the present embodiment, the movable range of the adjustment is constituted of an air gap. Therefore, the heat radiation of the LD chips 1602 and 1612 is low. Accordingly, the decrease in the heat radiation of the LD chips 1602 and 1612 may be prevented by filling the gap with a conductive paste.

The specific procedure for using the conductive paste is first to internally fill the recess 1601c with the conductive paste.

Next, the semiconductor laser device 1600 is placed on the mounting surface of the housing 1451 such that the projection 1453 is set in the recess 1601c.

The conductive paste, due to being pasty, does not disturb the thin metal plate 1601 from smoothly turning along the plane parallel to the mounting surface 1601a with respect to the housing 1451.

In addition, the conductive paste, due to being pasty, expands along the configuration of the recess 1601c.

Therefore, even if the projection 1453 is moved in the recess 1601c, the conductive paste does not substantially hinder the movement of the projection 1453. That is, the conductive paste does not exert a bad influence on the inclination adjustment of the LD chip 1602 in the direction of q∥.

Therefore, the rotational adjustment of the semiconductor laser device 1600, which has a plurality of light-emitting points, is performed around an arbitrary position without impairing the heat radiation property of the LD chip 1602.

No description is herein provided for the conductive paste because the conductive paste has already been availed on the market and put into practical use also for the heat radiation of IC (Integrated Circuit).

In the first through twenty-first embodiments, the optical pickup devices include the components provided for the conventional optical pickup device, such as a collimating lens, an object lens, a signal detection system, a focus control mechanism and so on. Neither description nor illustration is herein provided therefor.

The present invention can also be obtained by arbitrarily combining the first through twenty-first embodiments.

The invention being thus described, it will be obvious that the invention may be varied in many ways. Such variations are not be regarded as a departure from the spirit and scope of the invention, and all such modifications as would be obvious to one skilled in the art are intended to be included within the scope of the following claims.

1. A semiconductor laser device comprising:
a main body part having a mounting surface; and
a semiconductor laser element mounted on the mounting surface and having a front end surface from which laser light is emitted, wherein
a first turn guide mechanism is formed at the main body part, the first turn guide mechanism enabling the main body part to turn around a neighborhood of a light-emitting point of the semiconductor laser element along a plane parallel to the mounting surface.

2. The semiconductor laser device as claimed in claim 1, wherein
at least part of an edge portion of the main body part roughly overlaps a circumference of a circle centered at the light-emitting point in plan view.

3. The semiconductor laser device as claimed in claim 1, wherein
the main body part is formed by:
a metal plate having the mounting surface; and
a resin part formed integrally with the metal plate and provided with the first turn guide mechanism.

4. The semiconductor laser device as claimed in claim 1, wherein
the first turn guide mechanism is a radius portion formed at an edge portion of the main body part, and
the radius portion roughly overlaps a circular arc of a circle centered at the light-emitting point in plan view.

5. The semiconductor laser device as claimed in claim 1, wherein
the first turn guide mechanism is comprised of two first angled portions formed at an edge portion of the main body part, and
each apex of the first angled portions is located at a point on a circumference of a circle centered at the light-emitting point in plan view.

6. The semiconductor laser device as claimed in claim 5, wherein
a straight line, which extends through each of the ends of the first angled portions and the neighborhood of the light-emitting point, intersects a side surface of the main body part making an acute angle with respect to the side surface.

7. The semiconductor laser device as claimed in claim 3, wherein
a wire bonding wire is electrically connected to a surface of the semiconductor laser element, the surface being located opposite to the metal plate,
a surface of the resin part is higher than a portion of the wire bonding wire, the surface and the portion being located on a side opposite to the metal plate, and
the resin part is formed so as to face a rear end surface and two side surfaces of the semiconductor laser element.

8. The semiconductor laser device as claimed in claim 3, wherein
the resin part is formed of a resin material having electrical conductivity.

9. The semiconductor laser device as claimed in claim 8, wherein
the resin material contains powdery metal or particulate metal.

10. The semiconductor laser device as claimed in claim 1, wherein
the first turn guide mechanism is a recess formed on a surface of the main body part, the surface being located on a side opposite to the semiconductor laser element.

11. The semiconductor laser device as claimed in claim 10, wherein
the recess is formed so as to roughly overlap the light-emitting point.

12. The semiconductor laser device as claimed in claim 10, wherein
the recess has an open portion on a side of the front end surface of the semiconductor laser element.

13. The semiconductor laser device as claimed in claim 10, wherein
the recess is a groove that roughly overlaps a circumference of a circle centered at the light-emitting point in plan view.

14. The semiconductor laser device as claimed in claim 10, wherein
the recess is a cut formed at an edge portion of the main body part, and
the cut has a width approximately equal to that of the semiconductor laser element.

15. An optical pickup device comprising:
the semiconductor laser device claimed in claim 1; and
a housing having a mounting surface to which the semiconductor laser device is attached, wherein
a second turn guide mechanism is formed at the housing, the second turn guide mechanism enabling the main body part to turn around a neighborhood of the light-emitting point of the semiconductor laser element along a plane parallel to the mounting surface with respect to the housing.

16. An optical pickup device comprising:
the semiconductor laser device claimed in claim 4; and
a housing having a mounting surface to which the semiconductor laser device is attached, wherein
a second turn guide mechanism is formed at the housing, the second turn guide mechanism enabling the main body part to turn around a neighborhood of the light-emitting point of the semiconductor laser element along a plane parallel to the mounting surface with respect to the housing,
the second turn guide mechanism is a curved surface that comes in contact with the radius portion, and
the curved surface roughly overlaps a circular arc of a circle centered at the light-emitting point in plan view.

17. An optical pickup device comprising:
the semiconductor laser device claimed in claim 4; and
a housing having a mounting surface to which the semiconductor laser device is attached, wherein
a second turn guide mechanism is formed at the housing, the second turn guide mechanism enabling the main body part to turn around a neighborhood of the light-emitting point of the semiconductor laser element along a plane parallel to the mounting surface with respect to the housing,
the second turn guide mechanism is a plane that comes in contact with the radius portion, and
the plane roughly overlaps a tangential line to the radius portion.

18. An optical pickup device comprising:
the semiconductor laser device claimed in claim 4; and
a housing having a mounting surface to which the semiconductor laser device is attached, wherein
a second turn guide mechanism is formed at the housing, the second turn guide mechanism enabling the main body part to turn around a neighborhood of the light-emitting point of the semiconductor laser element along a plane parallel to the mounting surface with respect to the housing,
the second turn guide mechanism is comprised of two second angled portions that come in contact with the radius portion, and
apexes of the second angled portions roughly overlap points on a circumference of a circle centered at the light-emitting point in plan view.

19. An optical pickup device comprising:
the semiconductor laser device claimed in claim 5; and
a housing having a mounting surface to which the semiconductor laser device is attached, wherein
a second turn guide mechanism is formed at the housing, the second turn guide mechanism enabling the main body part to turn around a neighborhood of the light-emitting point of the semiconductor laser element along a plane parallel to the mounting surface with respect to the housing,
the second turn guide mechanism is a curved surface with which the first angled portion comes in contact, and
the curved surface roughly overlaps a circular arc of a circle centered at the light-emitting point in plan view.

20. An optical pickup device comprising:
the semiconductor laser device claimed in claim 10; and
a housing having a mounting surface to which the semiconductor laser device is attached, wherein
a second turn guide mechanism is formed at the housing, the second turn guide mechanism enabling the main body part to turn around a neighborhood of the light-emitting point of the semiconductor laser element along a plane parallel to the mounting surface with respect to the housing,
the second turn guide mechanism is a projection formed on the mounting surface, and
the projection is fit in the recess.
